(19) United States
(12) Patent Application Publication
(10) Pub. No.: US 2006/0101231 A1
(43) Pub. Date: May 11, 2006

(54) Semiconductor signal processing device

(75) Inventor: Motoki Higashida, Tokyo (JP)

Correspondence Address: McDermott Will & Emery LLP, 600 13th Street, N.W., Washington, DC, 20005-3096, US

(73) Assignee: Renesas Technology Corp.

(21) Appl. No.: 11/225,151

(22) Filed: Sep. 14, 2005

(30) Foreign Application Priority Data
Sep. 28, 2004 (JP) 2004-282014

(51) Int. Cl. G06F 15/00

(52) U.S. Cl. 712/10; 712/241

(57) ABSTRACT

An instruction for an arithmetic/logic operation to a main processing circuit is stored in the form of a micro program in a micro instruction memory, and the operation of the main processing circuit is controlled in accordance with the micro program, under the control of a controller. In the main processing circuit, a memory mat is divided into entries each storing data of a plurality of bits, and for each entry, a processor (ALU) is arranged. Arithmetic/logic operations are performed entry-parallel and in bit-serial manner between each entry and the associated ALU. In accordance with the micro program control method, a large amount of data can be processed efficiently. Thus, a processing device that efficiently performs an arithmetic/logic operation on a large amount of data at high speed is provided.

### CROSS REFERENCE TO RELATED APPLICATION

An invention related to the present application is disclosed in a co-pending application, U.S. Ser. No. 11/148,369, commonly assigned to the assignee of the present application.

### BACKGROUND OF THE INVENTION

1. Field of the Invention

The present invention relates to a semiconductor signal processing device and, more specifically, to a configuration of a signal processing integrated circuit device employing a semiconductor memory performing an arithmetic/logic operation on a large amount of data at high speed.

2. Description of the Background Art

Recently, along with wide spread use of portable terminal equipments, digital signal processing allowing high speed processing of a large amount of data including voice or audio and image data comes to have higher importance. For such digital signal processing, generally, a DSP (Digital Signal Processor) is used as a dedicated semiconductor device. Digital signal processing of voice and image includes data processing such as filtering, which frequently requires arithmetic operations with repetitive sum-of-products operations. Therefore, a general DSP is configured to have a multiplication circuit, an adder circuit and a register for accumulation. When such a dedicated DSP is used, the sum-of-products operation can be executed in one machine cycle, enabling a high-speed arithmetic/logic operation.

Prior art Reference 1 (Japanese Patent Laying-Open No. 06-324862) shows an arrangement, in which a register file is used to perform such a sum-of-products operation. According to prior art Reference 1, two-term operand data stored in the register file are read to be added by a processor, and the addition result is again written to the register file through a write data register. In the arrangement shown in Reference 1, a write address and a read address are simultaneously applied to the register file to execute data writing and data reading in parallel, and therefore, the processing time can be made shorter than the processing time in an arrangement having a data write cycle and a data read cycle being provided separately for an arithmetic/logic operation.

Prior art Reference 2 (Japanese Patent Laying-Open No. 05-197550) shows an arrangement aimed at high speed processing of a large amount of data. In this arrangement shown in Reference 2, a plurality of processors are arranged in parallel, with each processor containing a memory. To implement high-speed parallel operations, each processor individually generates a memory address.

Further, prior art Reference 3 (Japanese Patent Laying-Open No. 10-074141) shows a signal processing apparatus aimed at high speed execution of processing such as DCT (Discrete Cosine Transform) of image data. In the arrangement shown in Reference 3, image data are input in a bit-parallel and word-serial sequence, that is, in the word (pixel data) units, and therefore, the data are transformed into word-parallel and bit-serial data by a serial/parallel converter circuit and written to a memory array. Thereafter, the data are transferred to processors (ALUs) arranged corresponding to the memory array, and parallel operations are executed. The memory array is divided into blocks corresponding to image data blocks, and in each block, image data forming the corresponding image block are stored word by word for each row of the memory array.

In the arrangement shown in Reference 3, data are transferred on the word by word (data corresponding to one pixel) basis between the memory block and the corresponding processor. To realize high speed operation of filtering such as DCT, the same process is performed on the transferred word in the corresponding processor for each image block. The results of arithmetic/logic operations are again-written to the memory array, subjected to parallel/serial conversion so that the bit-serial and word-parallel data are converted to bit-parallel and word-serial data, and the resultant data are output successively line by line. In common processing, bit position of data is not converted, and common arithmetic/logic operations are executed on a plurality of data in parallel by the processors.

Prior art Reference 4 (Japanese Patent Laying-Open No. 2003-114797) shows a data processing apparatus aimed at executing a plurality of different arithmetic/logic operations in parallel. In the arrangement shown in Reference 4, a plurality of logic modules each having a limited function are connected to corresponding multi-port type data memories. As to the connection between the logic modules and the multi-port data memories, the memories and the ports of the multi-port memories to be connected to the logic modules are limited. Therefore, an address area available for data reading and writing by each logic module accessing the multi-port data memories is limited. The result of operation by each logic module is written to a data memory to which access is allowed, and through the multi-port memories, data are successively transferred through the logic modules, to implement data processing in a pipeline manner.

When the amount of data to be processed is very large, even a dedicated DSP is insufficient to attain dramatic improvement in performance. By way of example, when the data to be operated includes 10,000 sets and an operation of each data set can be executed in one machine cycle, at least 10,000 cycles are necessary to complete the operation. Therefore, although each process can be done at high speed in an arrangement in which the sum-of-products operation is performed using a register file as described in Reference 1, when the amount of data increases, the time of processing increases in proportion thereto as the data are processed in series, and therefore, such an arrangement cannot achieve high speed processing for a large amount of data. When a dedicated DSP is used, the processing performance much depends on an operating frequency, and therefore, if high speed processing were given priority, power consumption would considerably be increased.

A register file and processors in the system as described in Reference 1 are dedicatedly designed for a specific application in many cases, so that the operation bit width and configuration of processing circuit tend to be fixed. When the arrangement is to be diverted to other application, the bit width, configuration of processing circuit and the others must be re-designed, and hence, it lacks flexibility for a plurality of different applications including arithmetic/logic operations.

In the arrangement described in Reference 2, each processor contains a memory, and each processor makes an access to a different memory address area for processing. The data memory and the processor are arranged in separate areas, and in a logic module, address transfer and data access must be done between the processor and the memory. This means that data transfer takes time, the machine cycle cannot be made shorter and hence, high speed processing is hindered.

The arrangement described in Reference 3 is to increase speed of processing such as DCT of image data, and in this arrangement, pixel data of one line of an image screen are stored in one row of memory cells, and image blocks aligned along the row direction are processed in parallel. Therefore, when the number of pixels per line increases to realize very fine images, the memory array arrangement would be of an impermissible size. Assume that data of one pixel consists of 8 bits and one line has 512 pixels, the number of memory cells of one row of memory cells will be 8×512=4 k bits, a row selecting line (word line) connecting to one row of memory cells has an increased load, and it becomes difficult to select at high speed the memory cells for transferring data between the operational processing portion and the memory cells, hindering high speed processing.

Reference 3 shows an arrangement in which the memory cell arrays are positioned on opposite sides of a group of processing circuits, but fails to show specific configuration of the memory array. Further, although this reference shows an arrangement of processors in an array, specific arrangement of the group of processors is not detailed at all.

Reference 4 arranges a plurality of multi-port data memories and a plurality of processors (ALUs) of low function that can access only a limited area of the multi-port memories. The processors (ALUs) and the memories, however, are arranged on different areas. Therefore, because of line capacitance and the like, high-speed data transfer is difficult, and even when pipeline processing is performed, the machine cycle of the pipeline cannot be made shorter.

References 1 to 4 do not consider at all how to accommodate for data having different word configurations as the object of arithmetic/logic operation.

### SUMMARY OF THE INVENTION

An object of the present invention is to provide a semiconductor signal processing device capable of processing a large amount of data at high speed.

Another object of the present invention is to provide a semiconductor signal processing device capable of executing an arithmetic/logic operation at high speed, regardless of word configuration of data or contents of arithmetic/logic operation.

A further object of the present invention is to provide a semiconductor signal processing device having arithmetic/logic operation function, allowing flexible change in contents of processing.

The semiconductor signal processing device according to the present invention includes: a memory array having a plurality of memory cells arranged in rows and columns and divided into a plurality of entries each having a plurality of memory cells; a main processing circuit including a plurality of processing circuits arranged corresponding to respective entries of the memory array; a micro instruction memory for storing micro instructions; and a control circuit for controlling operations of the memory array and the plurality of processing circuits, in accordance with a micro instruction from the micro instruction memory.

The memory array is divided into a plurality of entries, and a processing circuit is arranged for each entry. Operations such as data transfer between the memory array and the processing circuits, data writing/reading and arithmetic/logic operation are controlled in accordance with the micro instructions from the micro instruction memory, and therefore, the processes can be executed substantially at the same speed as in a common wired logic. Further, contents of arithmetic/logic operations can be changed by the micro program instructions, and therefore, different contents of arithmetic/logic operations can flexibly be accommodated for.

Further, as the arithmetic/logic operation is executed in parallel on the plurality of entries, arithmetic/logic operations on a large amount of data can be processed at high speed.

Further, by a configuration in which the same data word is stored in each entry and arithmetic/logic operation is performed in corresponding processing circuits in a bit-serial manner, arithmetic/logic operation can be performed even when word configuration (bit width) of the data is changed, without necessitating significant change in hardware.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 schematically shows a configuration of a signal processing system according to a first embodiment of the present invention.

FIG. 2 shows a configuration of a main portion of the main processing circuit shown in FIG. 1.

FIG. 3 shows an exemplary configuration of a memory cell included in the memory mat shown in FIG. 1.

FIG. 4 illustrates a processing operation by the main processing circuit shown in FIG. 1.

FIG. 5 shows a process sequence of the processing operation of FIG. 4.

FIG. 6 schematically shows a configuration of a basic operation block according to the first embodiment of the present invention.

FIG. 7 shows an example of a micro program in accordance with the first embodiment of the present invention.

FIG. 8 is a timing chart representing an address updating operation shown in FIG. 7.

FIG. 9 shows an exemplary configuration of the ALU shown in FIG. 6.

FIG. 10 schematically shows a configuration of a basic operation block according to a second embodiment of the present invention.

FIG. 11 shows an example of a micro program used in the second embodiment of the present invention.

FIG. 12 is a flow chart representing a processing operation of the micro program shown in FIG. 11.

FIG. 13 schematically shows a configuration of a basic operation block according to a third embodiment of the present invention.

FIG. 14 shows an exemplary configuration of a memory cell included in a memory cell mat shown in FIG. 13.

FIG. 15 schematically shows an exemplary configuration of the ALU shown in FIG. 13.

FIG. 16 schematically represents a data transfer operation of the main processing circuit shown in FIG. 13.

FIG. 17 shows an example of a micro program of the semiconductor signal processing device in accordance with the third embodiment of the present invention.

FIG. 18 shows an example of an image data processing according to a fourth embodiment of the present invention.

FIG. 19 schematically shows a configuration of a main portion of the semiconductor signal processing device according to the fourth embodiment of the present invention.

FIG. 20 is a flow chart representing a data processing sequence of the semiconductor signal processing device according to the fourth embodiment of the present invention.

FIG. 21 schematically shows a data flow of the process sequence shown in FIG. 20.

FIG. 22 schematically shows areas for storage data and transfer data in the memory cell mat in accordance with the fourth embodiment of the present invention.

FIG. 23 schematically shows a configuration of a processing circuit according to a fifth embodiment of the present invention.

FIG. 24 shows a schematic configuration of the main processing circuit shown in FIG. 23.

FIG. 25 schematically shows a configuration of the semiconductor signal processing device according to a sixth embodiment of the present invention.

FIG. 26 schematically shows allocation of data storage areas of the memory cell mat shown in FIG. 25.

FIG. 27 schematically shows a configuration of the semiconductor signal processing device according to a seventh embodiment of the present invention.

FIG. 28 schematically shows a configuration of a transposing circuit shown in FIG. 27.

FIG. 29 is a flow chart representing a data transfer operation of the transposing circuit shown in FIG. 28.

FIG. 30 schematically shows data flow at the time of data transfer by the transposing circuit in accordance with the seventh embodiment of the present invention.

FIG. 31 shows an exemplary configuration of the memory cell included in the transposing memory shown in FIG. 28.

### DESCRIPTION OF THE PREFERRED EMBODIMENTS

### First Embodiment

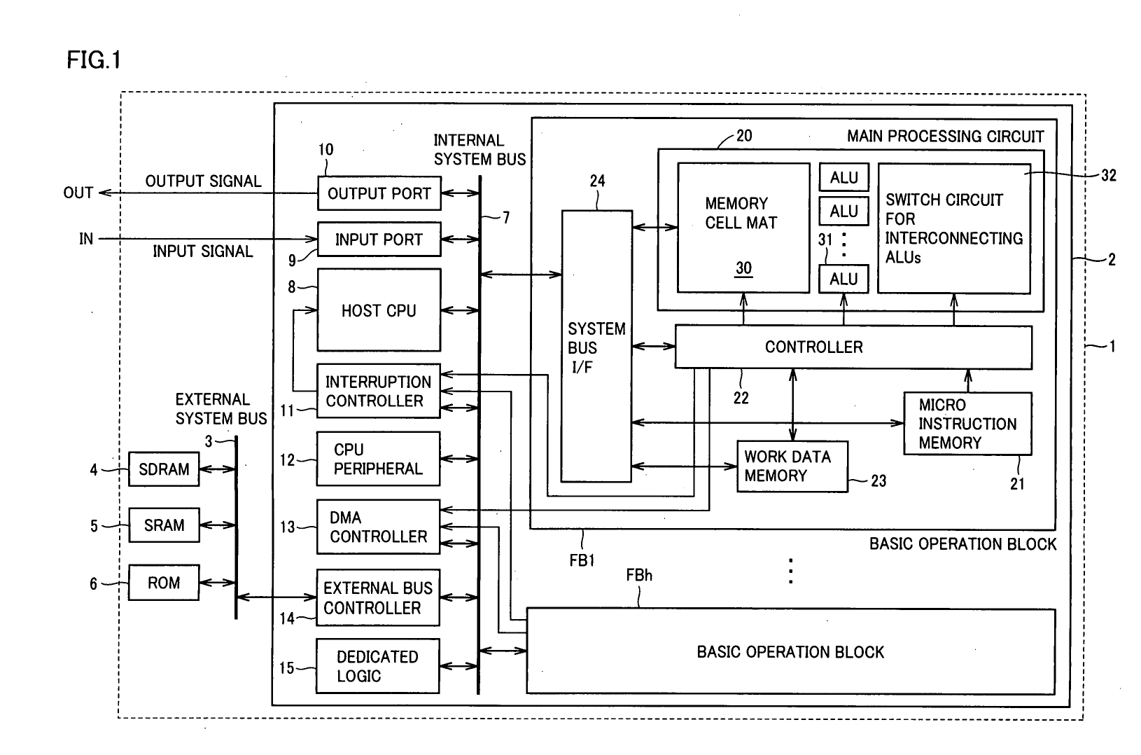

FIG. 1 schematically shows an overall configuration of the processing system in which the semiconductor signal processing device according to the present invention is used. Referring to FIG. 1, the signal processing system 1 includes a system LSI 2 implementing arithmetic/logic functions for executing various processes, and an external memory connected to system LSI 2 through an external system bus 3. The external memory includes a large capacity memory 4, a high speed memory 5, and a read only memory (ROM) 6 for storing fixed information such as boot instructions. Large capacity memory 4 is formed, for example, of a clock-synchronous type dynamic random access memory (SDRAM), and high speed memory 5 is formed, for example, of a static random access memory (SRAM).

The specific configuration of the shown system LSI is disclosed in a co-pending U.S. patent Application, U.S. Ser. No. 11/148,369, commonly assigned to the assignee of the present application. The contents of the co-pending U.S. Application are incorporated herein by reference, and the description of the detailed configuration of the system LSI disclosed therein constitutes a part of the present specification. In the following, the configuration of the system LSI will be briefly described.

The system LSI includes basic operation blocks FB1-FBh coupled in parallel with an internal system bus 7; a host CPU 8 coupled to internal system bus 7, and controlling processing operations of these basic operation blocks FB1-FBh; an input port 9 converting an input signal IN from the outside of system 1 to data for internal processing; and an output port 10 receiving output data applied from internal system bus 7 and generating an output signal OUT to the outside of the system. Input port 9 and output port 10 are formed, for example, of IP (Intellectual Property) blocks prepared as libraries, and implement the functions necessary for input and output of data and/or signal.

System LSI 2 further includes: an interruption controller 11 receiving an interruption signal from basic operation blocks FB1-FBh and signaling a host CPU 8 of an interruption; a CPU peripheral 12 performing control operations necessary for various processes by host CPU 8; a DMA (Direct Memory Access) controller 13 transferring data between external memory and basic operation blocks FB1-FBh in accordance with a transfer request from basic operation blocks FB1-FBh; an external bus controller 14 controlling access to the memories 4-6 connected to external system bus 3, in accordance with an instruction from DMA controller 13 or CPU 8; and a dedicated logic 15 supporting data processing by host CPU 8.

CPU peripheral 12 has functions necessary for the operations of programming and debugging in host CPU 8, such as a timer and serial IO (Input/Output). Dedicated logic 15 is formed, for example, of an IP block, and using existing functional blocks, implements necessary processing functions. These functional blocks 9-15 are connected to internal system bus 7. Further, DMA request signals from basic operation blocks FB1-FBh are applied to DMA controller 13.

Basic operation blocks FB1-FBh have the same configuration with each other and therefore, FIG. 1 shows, as a representative, the configuration of basic operation block FB1.

Basic operation block FB1 includes: a main processing circuit 20 performing actual arithmetic/logic operations on the data; a micro instruction memory 21 for storing micro instructions designating arithmetic/logic operations of main processing circuit 20; a controller 22 for controlling the arithmetic/logic operations of main processing circuit 20 in accordance with a micro instruction from micro instruction memory 21; a work data memory 23 for storing intermediate processing data or work data of controller 22; and a system bus interface (I/F) 24 for transferring data/signal between internal system bus 7 and the internal circuitry of basic operation block FB1.

Main processing circuit 20 includes a memory cell mat 30 having a plurality of memory cells arranged in rows and columns and divided into a plurality of entries; processors (ALUs) 31 arranged corresponding to the respective entries of memory cell mat 30 and performing a designated arithmetic/logic operation, and a switch circuit 32 for interconnecting ALUs to set a data transfer path among processors 31.

Basically, each row (memory cell column) of memory cell mat 30 forms one entry, and all the bits of multi-bit data are stored in one entry. Processor (hereinafter, also appropriately referred to as ALU) 31 receives data from the corresponding entry in a bit-serial manner, performs an arithmetic/logic operation, and stores the result of operation in a designated entry (for example, the corresponding entry) of memory cell mat 30.

By switch circuit 32 for interconnecting ALUs, connection paths of ALUs 31 are switched, to enable operation on data of different bit lines (different entries). By storing different data in different entries and performing parallel arithmetic/logic operation by ALUs 31, high speed data processing becomes possible.

Controller 22 performs an operation in accordance with a micro program scheme, in accordance with micro instructions stored in micro instruction memory 21. Work data necessary for the micro program operation is stored in work data memory 23.

By system bus I/F 24, host CPU 8 or DMA controller 13 may access memory cell mat 30, a control register in controller 22, micro instruction memory 21 and work data memory 23.

Different address areas (CPU address areas) are allocated to basic operation blocks FB1-FBh. Similarly, different addresses (CPU addresses) are allocated to memory cell mat 30, control register in controller 22, micro instruction memory 21 and work data memory 23, respectively. Therefore, when micro instructions of different contents are stored in different basic operation blocks FB1-FBh, different arithmetic/logic operations can be executed in parallel. Alternatively, micro instructions of the same contents of arithmetic/logic operation may be stored in micro instruction memory 21, so that the same arithmetic/logic operation is performed on data in different address areas, in basic operation blocks FB1-FBh.

In accordance with each allocated address region, host CPU 8 and DMA controller 13 identifies the basic operation block FB (FB1-FBh) to be accessed, and makes an access to the basic operation block of access target.

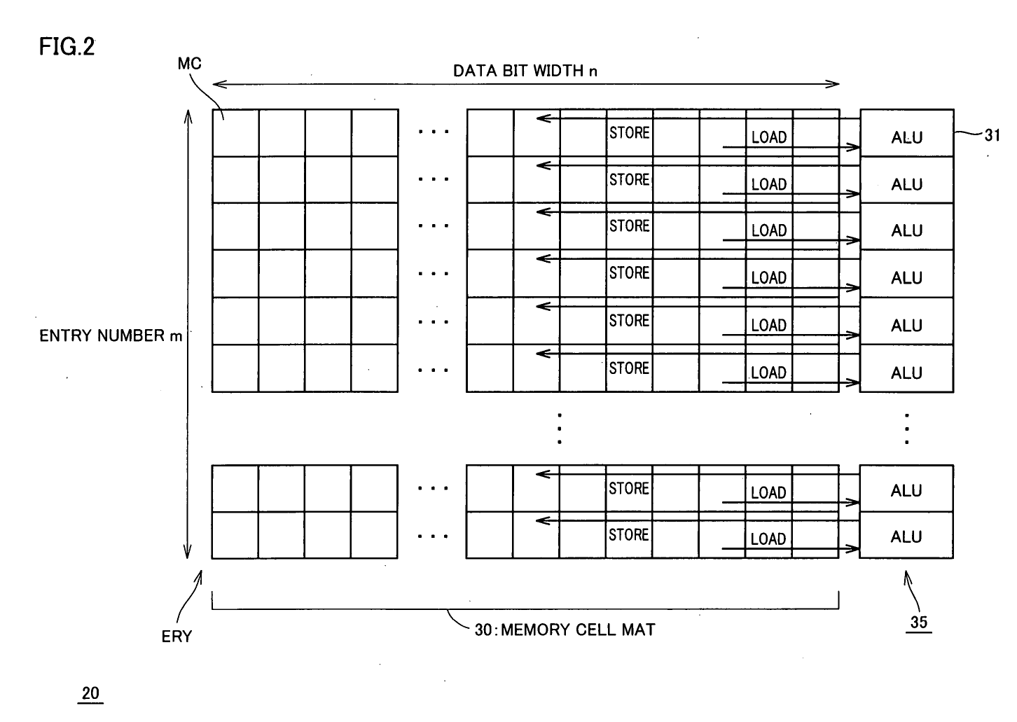

FIG. 2 schematically shows a configuration of a main portion of main processing circuit 20 included in each of basic operation blocks FB1-FBh shown in FIG. 1. Referring to FIG. 2, in memory cell mat 30, memory cells MC are arranged in rows and columns. Memory cells MC are divided into m entries ERY. An entry ERY has a bit width of n bits. Basically, one entry ERY consists of memory cells MC aligned in one column. Therefore, the number of entries ERY is, in this case, determined by the number of rows of memory mat 30, that is, the number of bit lines.

In arithmetic logic unit group 35, for each entry ERY, an ALU 31 is provided. ALU 31 is capable of executing arithmetic/logic operations such as addition, logical product, coincidence detection (EXOR), inversion (NOT) and the others.

An arithmetic/logic operation is performed by loading data (transferring data from memory cell mat 30 to arithmetic/logic unit group 35) and storing data (transferring and storing data from the arithmetic logic unit group 35 to memory cell mat 30) between the entry ERY and the corresponding ALU 31. In the entry ERY, respective bits of multi-bit data are stored at different bit positions, and ALU 31 executes an arithmetic/logic operation in a bit-serial manner, in which multi-bit data word is processed bit by bit. In the arithmetic logic unit group 35, an arithmetic/logic operation of data is executed in bit-serial manner on the data word and entry parallel manner with the plurality of entries ERY being processed in parallel.

By changing the bit width of the entry ERY, data processing can be executed simply by changing the number of operation cycles (range of an address pointer), even when the data words have different word configurations. Further, by increasing the number of entries m, it becomes possible to perform an arithmetic/logic operation on a large amount of data.

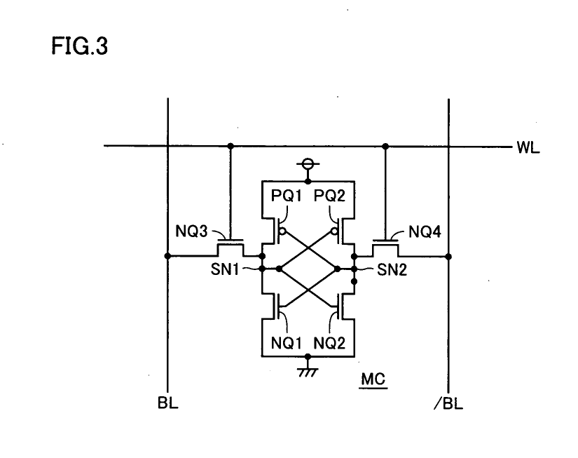

FIG. 3 shows an exemplary configuration of the memory cell MC shown in FIG. 2. Referring to FIG. 3, memory cell MC includes: a P channel MOS transistor (insulated gate type field effect transistor) PQ1 connected between a power supply node and a storage node SN1 and having its gate connected to a storage node SN2; a P channel MOS transistor PQ2 connected between the power supply node and storage node SN2 and having its gate connected to storage node SN1; an N channel MOS transistor NQ1 connected between storage node SN1 and a ground node and having its gate connected to storage node SN2; an N channel MOS transistor NQ2 connected between storage node SN2 and the ground node and having its gate connected to storage node SN1; and N channel MOS transistors NQ3 and NQ4 connecting storage nodes SN1 and SN2 to bit lines BL and /BL, respectively, in response to the potential on word line WL.

The memory cell MC shown in FIG. 3 is an SRAM cell having a full CMOS (Complementary MOS) structure, and capable of high speed data writing/reading. By using the SRAM cells, refreshing of stored data becomes unnecessary in memory cell mat 30, operation control is facilitated, and an arithmetic/logic operation can be executed at high speed.

When an arithmetic/logic operation is to be performed by main processing circuit 20, first, data of the object of operation are stored in the respective entries ERY. Thereafter, bits of a certain digit of the stored data are read in parallel from all the entries ERY, and transferred (loaded) to the corresponding ALUs 31. For a two-term operation, similar transfer operation takes place on a bit of different data word in each entry, and 2-term operation is performed by each ALU 31. The result of arithmetic/logic operation is rewritten (stored) in a prescribed area of the corresponding entry ERY from ALU 31.

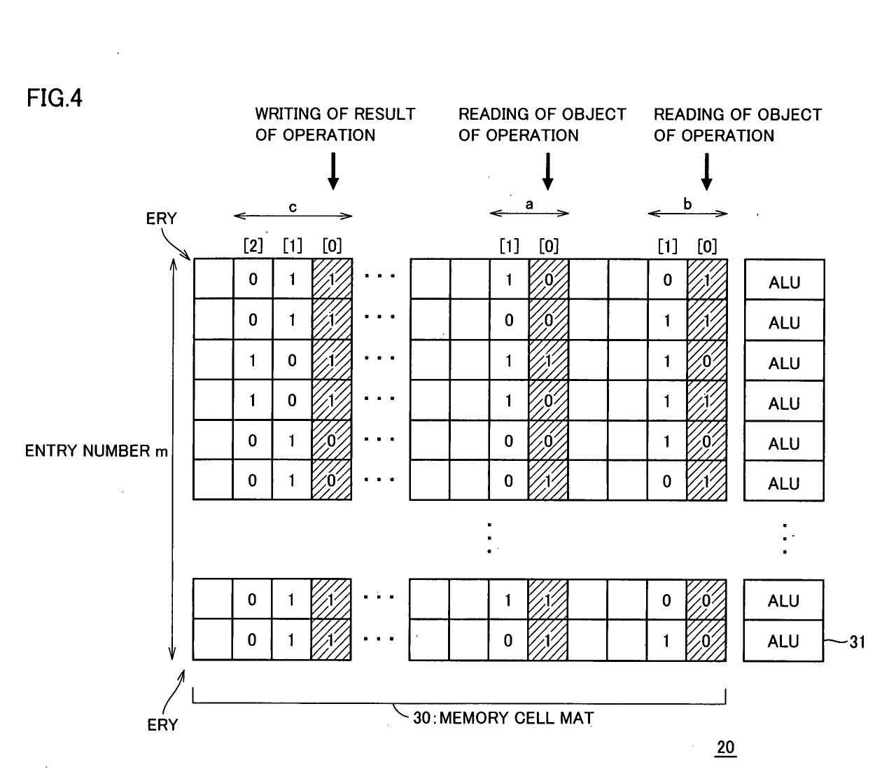

FIG. 4 shows an exemplary arithmetic/logic operation performed by main processing circuit 20 shown in FIG. 2. Referring to FIG. 4, data words “a” and “b” having the bit width of 2 bits are added to generate a data word “c.” In each entry ERY, data words “a” and “b” forming a set of an object of arithmetic/logic operation are both stored.

Referring to FIG. 4, in ALU 31 corresponding to the entry ERY of the first row, an operation of 10B+01B is performed, whereas in ALU 31 corresponding to the entry ERY of the second row, an operation of 00B+11B is performed. Here, “B” at the end represents a binary number. In ALU 31 corresponding to the entry ERY of the third row, an operation of 11B+10B is performed. In the similar manner, data words a and b stored in each entry are added. It should be noted that each entry is formed of a column of memory cells arranged in memory mat, and a word line is selected to select memory cells at the same position of each entry. The first row entry and other row entry indicates the row for the entries and do not coincide the memory cell rows.

The arithmetic/logic operation is performed in the bit-serial manner, starting at the lowest bits. First, in entry ERY, a lower bit a [0] of data word a is transferred to the corresponding ALU 31. Thereafter, a lower bit b [0] of data word b is transferred to the corresponding ALU 31. ALU 31 performs an addition, using 2 bits of data thus supplied. The result of addition a [0]+b [0] is written (stored) to a position of lower bit c [0] of data word c. Specifically, in the entry ERY of the first row, “1” is written to the position of c [0].

This addition is performed on higher bits a [1] and b [1], and the result of operation a [1]+b [1] is written to the position of c [1].

An addition may possibly produce a carry, and the carry value is written to a position of c [2]. Thus, addition of data words a and b completes in every entry ERY, and the result is stored in each entry ERY as data c. Assuming that the number of entries m is 1024, addition of 1024 sets of data can be executed in parallel.

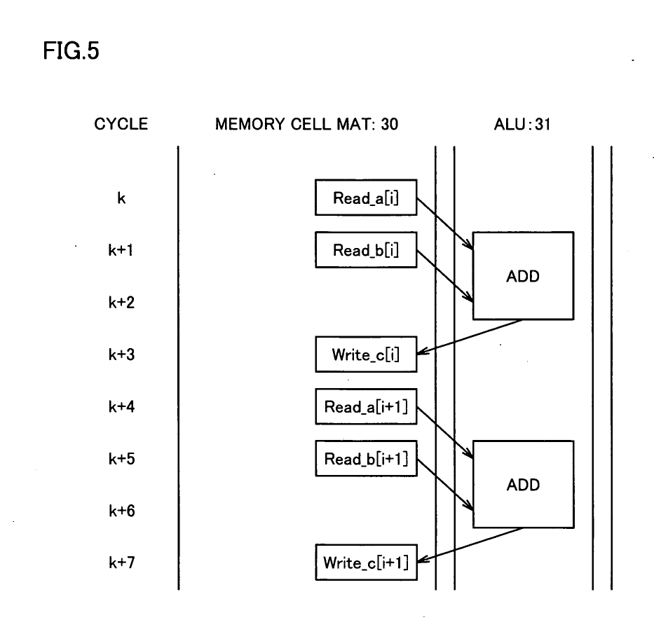

FIG. 5 schematically shows internal timings during the addition operation. In the following, internal timings of addition will be described with reference to FIG. 5. For the addition, a 1-bit adder (ADD) in ALU 31 is used.

In FIG. 5, “Read” represents an operation (load) or operation instruction of reading a data bit to be processed from the memory mat and transferring to the corresponding ALU 31, and “Write” represents an operation (store) or operation instruction of writing the data of the result of operation of ALU 31 to a corresponding bit position of the corresponding entry.

In a machine cycle k, a data bit a[i] is read from memory mat 30, in the next machine cycle (k+1), the data bit b[i] of the other term of adding operation is read (Read), and applied to the adder (ADD) of ALU 31.

In machine cycle (k+2), in the adder (ADD) of ALU 31, the applied data bits a[i] and b[i] are added, and in machine cycle (k+3), the result of addition c[i] is written to the corresponding position of the corresponding entry.

In machine cycles (k+4) and (k+5), data bits a[i+1] and b[i+1] are read and transferred to the adder (ADD) of ALU 31, in machine cycle (k+6), ALU 31 performs addition, and in machine cycle (k+7), the result of addition is stored in bit position c[i+1].

Transfer of a data bit between memory mat and ALU 31 requires one machine cycle, and ALU 31 requires an operation cycle of one machine cycle. Therefore, addition of 1-bit data and storage of the result of addition require 4 machines cycles in total. The arrangement, in which the memory mat 30 is divided into a plurality of entries, sets of data to be processed are stored in respective entries, and arithmetic/logic operation is performed by corresponding ALUs 34 in bit-serial manner, is characterized in that relatively large number of machine cycles are necessary for the arithmetic/logic operation of each data, whereas high speed data processing can be achieved by increasing degree of parallel operations when an extremely large amount of data are to be processed.

When the data word of the object of an arithmetic (add/sub) or logic operation has the bit width of N, an arithmetic (add/sub) or logic operation by each entry requires 4×N machine cycles. The bit width of the data word of the object of arithmetic (add/sub) or logic operation is generally within a range of 8 to 64 bits. Therefore, when the number of entries m is set relatively large to 1024 and data of 8 bit width are to be processed in parallel, 1024 results of arithmetic operations can be obtained after 32 machine cycles. Thus, necessary time of processing can significantly be reduced as compared with sequential processing of 1024 sets of data.

Further, the arithmetic/logic operation is performed in a bit-serial manner, and the bit width of the data to be processed is not fixed. Therefore, this scheme can readily be applied to various applications having various data configurations.

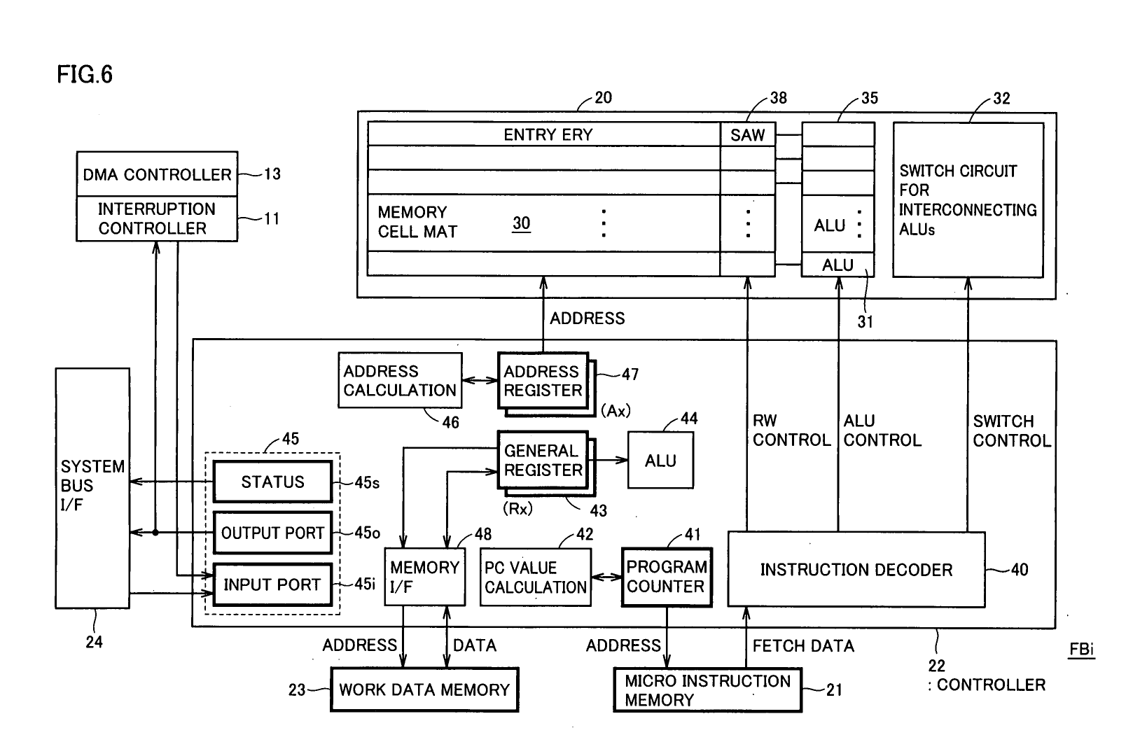

FIG. 6 shows a configuration of a controller 22 in a basic operation block FBi. In basic operation block FBi, main processing circuit 20 includes, as in the configuration shown in FIG. 1, memory cell mat 30, arithmetic logic unit group 35 and switch circuit 32 for interconnecting ALUs. FIG. 6 also shows a read/write circuit 38 provided between memory cell mat 30 and arithmetic logic unit group 35. Read/write circuit 38 includes a sense amplifier and write driver SAW provided corresponding to each entry ERY. In memory cell mat 30, word lines are provided common to the entries ERY along the entry column direction, and bit lines forming a pair are arranged in each entry. In FIG. 6, circuits for selecting an entry column (word line) and an entry row (bit line) of memory mat 30 are not shown.

Controller 22 includes: an instruction decoder 40 for decoding data fetched from micro instruction memory 21 and generating various control signals; a program counter 41 generating an address to micro instruction memory 21; a PC (program count) calculating unit 42 for updating a count of program counter 41; a general register group 43 including a plurality of general registers Rx; a processing circuit (ALU) 44 executing an operation such as condition determination on the contents of general registers in general register group 43; and a control register group 45 storing various pieces of control information for the basic operation block FBi. Control register group 45 includes a control register (status register 45s) for storing the result executed by processor (ALU) 44, and an output port register 45o and an input port register 45i communicating with interruption controller 11, DMA controller 13 and host CPU.

Controller 22 further includes: an address calculating unit 46 for calculating an address of memory cell mat 30; and an address register group 47 for storing and applying to main processing circuit 20 the address calculated by address calculating unit 46. Address register group 47 includes an address register Ax generating an address for each data in the entries.

Micro instruction memory 21 stores a micro program in which necessary sequence processing is coded. Instruction decoder 40 decodes a micro instruction fetched from micro instruction memory 21, generates a control signal to each module of controller 22, and generates a control signal for main processing circuit 20. The necessary process can be executed at high speed by a so called firmware. Referring to FIG. 6, instruction decoder 40 is shown providing, as representative examples, a read/write control signal (RW control) to sense amplifier/write driver SAW included in read/write circuit 38, an ALU control signal designating contents of operation to be executed and supplied to ALU 31 included in arithmetic logic unit group 35, and a switch control signal controlling connection in switch circuit 32 for interconnecting ALUs.

In controller 22, a memory interface (I/F) 48 is provided, for loading/storing data between general register group 43 and work data memory 23.

Host CPU (8) shown in FIG. 1 monitors the status of execution of controller 22 by the data stored in status register 45s included in control register group 45, and confirms the status of operation of basic operation block FBi. Host CPU (8) transfers the control through system bus interface 24 to controller 22, and controller 22 controls the processing operation in basic operation block FBi.

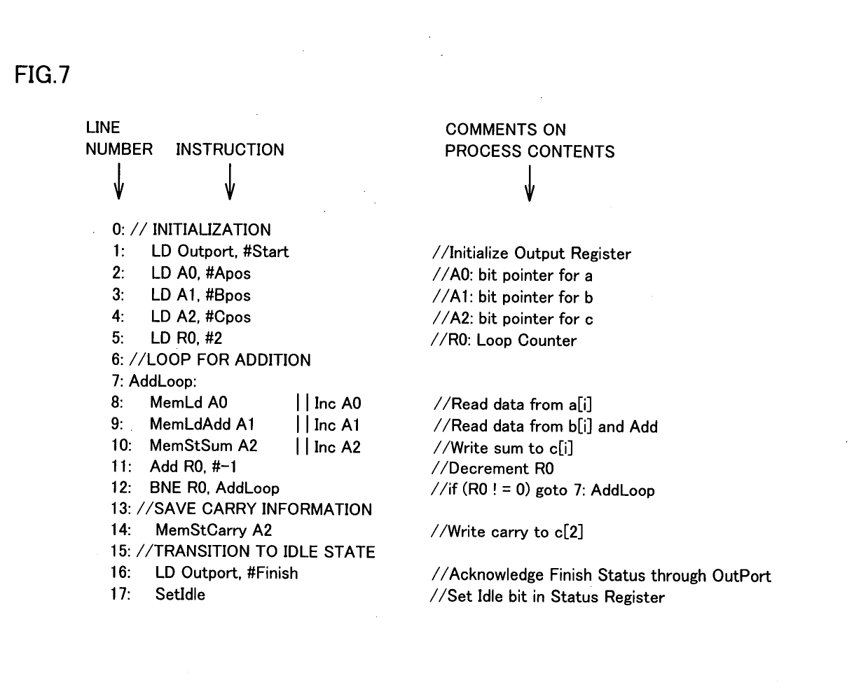

FIG. 7 shows an example of a micro program described in micro instructions corresponding to the addition shown in FIG. 4. Referring to FIG. 7, following the line number of the micro program, a micro instruction to be executed is described. In the strings of micro instructions, “//” is an index defining the contents to be processed, for the next string of instructions. For each line of instruction, following “//” on the right side, a comment stating the contents of processing by the corresponding instruction is provided. The instruction that is executed as the micro instruction is the instruction following the line number.

The instruction “LD Ax, #imm” is for setting a constant value #imm in address register Ax included in address register group 47.

The instruction “LD Rx, #imm” is for setting the constant value #imm in general register Rx included in general register group 43.

The instruction “LD Outport, #imm” is for setting the constant value #imm in output port register 45o included in control register group 45.

The instruction “Set Idle” is for setting an idle bit representing an idle state in status register (control register) 45s of control register group 45.

The instruction “Inc Ax” is an instruction to add 1 to address register Ax.

The instruction “BNE Rx, Label” is a branch instruction, indicating a branch to the instruction represented by “Label”, when the register value of general register Rx is not 0.

The instruction “Add Rx, #imm” is for adding the constant value #imm to the value stored in general register Rx. The addition is executed with a sign, and a negative value can be designated for the constant value #imm.

The instruction “MemLd Ax” is a control instruction for main processing circuit 20, for loading data from an address of memory cell mat 30 indicated by the address stored in address register Ax to arithmetic logic unit group 35. The loaded data is held by a flop-flop (or a register) included in ALU 31.

The instruction “MemLdAdd Ax” is for loading data from the address of memory cell mat 30 indicated by the value stored in address register Ax to ALU 31, and to add the loaded data to the value held in ALU 31. The result of addition, that is, sum and carry information is each held in a flip-flop (register) in ALU 31.

The instruction “MemStSum Ax” is for writing the contents of the flip-flop (register circuit) holding the sum information in ALU 31 to an address position indicated by address register Ax in memory cell mat 30.

The instruction “MemStCarry Ax” is for writing contents of the flip-flop (register circuit) holding the carry information in ALU 31 to the address position indicated by the stored value of address register Ax in memory cell mat 30.

Execution of each instruction requires one instruction cycle. In the lines of instructions, instructions described on one line with “∥” in between are instructions executed in parallel in the same instruction cycle. In the following, the contents to be processed by the program shown in FIG. 7 will be described.

In line #0, simply a comment of initialization is described, and no process is executed. By the instruction of line #1, a start bit #Start for executing an addition operation is loaded to output port register 45o. Accordingly, initialization of output port register 45o is executed.

From lines #2 to #4, pointers #Apos, #Bpos and #Cpos indicating address positions of data a and b and result of addition c, respectively, are set in address registers A0, A1 and A2 of address register group 47, respectively.

By the instruction of line #5, constant value 2 is stored in general register R0 in general register group 43, and the number of loops for loop processing is set. The loop process indicates that the addition operation is repeated for each set of data bits due to bit-serial processing.

By line #8, the bit at the position of address register A0 is selected in the memory cell mat, and loaded to ALU 31. In the same cycle as the load operation, the pointer of address register A0 is incremented by 1.

By line #9, the bit b [i] indicated by the pointer of address register A1 of memory cell mat is selected and loaded to ALU 31, and addition of bits a [i] and b [i] is executed. In this cycle, again, the pointer value of address register A1 is incremented by 1.

By line #10, the result of addition Sum is stored in bit position c [i] indicated by address pointer A2 of the memory cell mat. Here, the pointer of address register A2 is incremented by 1.

By the instruction of line #11, (−1) is added to the stored value of general register R0, that is, the stored value of general register R0 is decremented by 1, and it is indicated that an addition operation is performed once.

In line #12, when the stored value of general register R0 is not 0, the operation returns to the loop label AddLoop of line #7. When the stored value of general register R0 is 0, it means that an addition operation of 2 bits has been complete, and therefore, the operation proceeds to the next line, #13. Line #13 is simply a comment representing contents of the following process, and no operation is executed.

By line #14, the bit held by the flip-flop (register) storing the carry of ALU 31 is stored in a position represented by the pointer value c [2] of address register A2 of the memory cell mat.

In line #15, a comment representing the contents of the subsequent processes is provided, indicating that an instruction to make transition to the standby state is executed.

By line #16, as the process has been complete, an integer value Finish indicating the end of processing is set in output port register 45o, and by line #17, in status register 45s, an idle bit is set. By the processes according to lines #16 and #17, basic operation block FBi signals external host CPU 8 and the others of the end of addition operation.

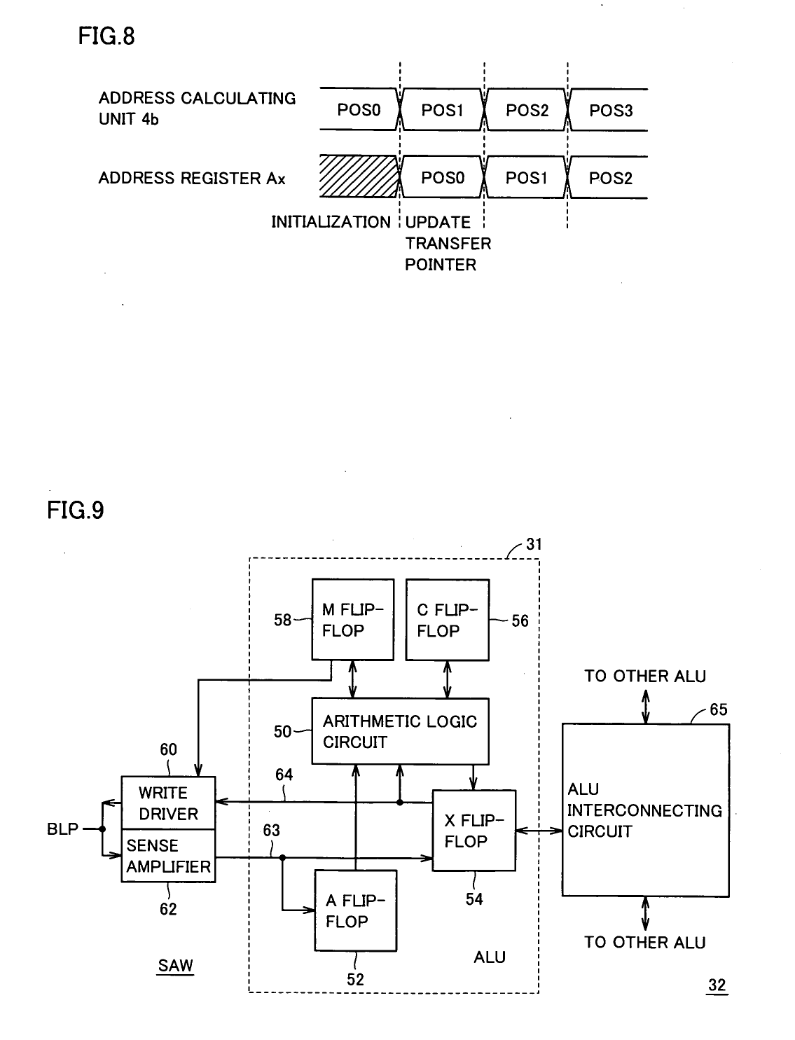

FIG. 8 is a timing chart representing an update of an address value, in accordance with the instructions on instruction lines #8 to #10 of FIG. 7. First, by the initialization instruction sequence, an initial address POS0 is set to address calculating unit 46. When the addition operation loop is executed, the address pointer POS0 stored in address calculating unit 46 is set and stored in address register Ax, and data transfer is executed (load/store). At this time, in address calculating unit 46, the address pointer is updated and the next address POS1 is designated. In the next cycle, the updated pointer POS1 for address calculating unit 46 is transferred to address register Ax. Thereafter, until the operation is complete, the address pointer of address calculating unit 46 and the pointer stored in address register Ax are updated in parallel with data transfer in accordance with the loop of addition processing loop AddLoop.

As address register group 4 is provided, address pointers Apos, Bpos and Cpos for respective data of the object of operation are generated and stored in corresponding address registers, the address updating cycle and the data transfer cycle can be set into the common cycle, and therefore, the number of cycles necessary for executing an instruction can be reduced.

FIG. 9 shows an example of the configuration of ALU 31. Referring to FIG. 9, ALU 31 includes: an arithmetic logic circuit 50 for performing a designated arithmetic/logic operation, an A flip-flop (register circuit) 52 for temporarily storing data read from the corresponding entry; an X flip-flop (register circuit) 54 for temporarily storing the data read from the corresponding entry, the data of the result of operation by the arithmetic logic circuit 50 or data to be transferred to a write driver; a C flip-flop (register circuit) 56 for storing a carry or a borrow at the time of addition/subtraction; and an M flip-flop (register circuit) 58 for storing mask data designating prohibition of an arithmetic/logic operation by arithmetic logic circuit 50 and prohibition of a write operation to the memory cell through the write driver 60.

The sense amplifier and write driver SAW shown in FIG. 6 includes a write driver 60 and a sense amplifier 62, provided corresponding to a bit line pair BLP (entry). Write driver 60 buffers the data stored in X flip-flop 54 and writes the result to the memory cell of the corresponding entry, through the corresponding bit line pair BLP. Sense amplifier 62 amplifies data read from the memory cell of the corresponding entry, and transfers the amplified data to A flip-flop 52 or X flip-flop 54 through internal data transfer line 63. X flip-flop 54 is coupled to arithmetic logic circuit 50 and write driver 60 through internal data transfer line 64.

Switch circuit 32 for interconnecting ALUs includes an ALU interconnecting circuit 65 provided corresponding to ALU 31. ALU interconnecting circuit 65 is formed, for example, with a switch matrix.

Arithmetic logic circuit 50 is capable of executing operations such as addition (ADD), logical product (AND), logical sum (OR), exclusive logical sum (EXOR: coincidence detection) and inversion (NOT), and the contents of operation are set by a control signal (ALU control of FIG. 6) from controller 22, based on a micro instruction. The mask data stored in M flip-flop 58 stops the arithmetic/logic operation of ALU 31 when it is “ ”, and enables the arithmetic/logic operation of ALU 31 when it is “1”. By utilizing the operation masking function, when not all the entries are utilized, operations can be executed only for the effective entries, so that accurate processing becomes possible. In addition, as execution of unnecessary operation is stopped, current consumption can be reduced.

When the above described two-term addition is performed by arithmetic logic circuit 50, an addition is performed by using a full adder, and the carry eventually stored in C flip-flop 56 is written to the corresponding bit position c [2] of the memory cell mat, in accordance with a micro instruction of line #14 of FIG. 7. The result of addition Sum is stored in X flip-flop 54.

As described above, in accordance with the first embodiment of the present invention, a micro instruction memory is provided in each basic operation blocks, and in accordance with the micro instructions stored in the micro instruction memory, data transfer (load/store) and arithmetic/logic operation are executed, and therefore, simply by changing the micro instruction, the contents of operation can desirably be switched.

Further, by providing an address register and an address calculating unit, address can be updated in parallel with the data transfer operation, so that the number of cycles necessary for an operation can be reduced and a high speed processing becomes possible.

### Second Embodiment

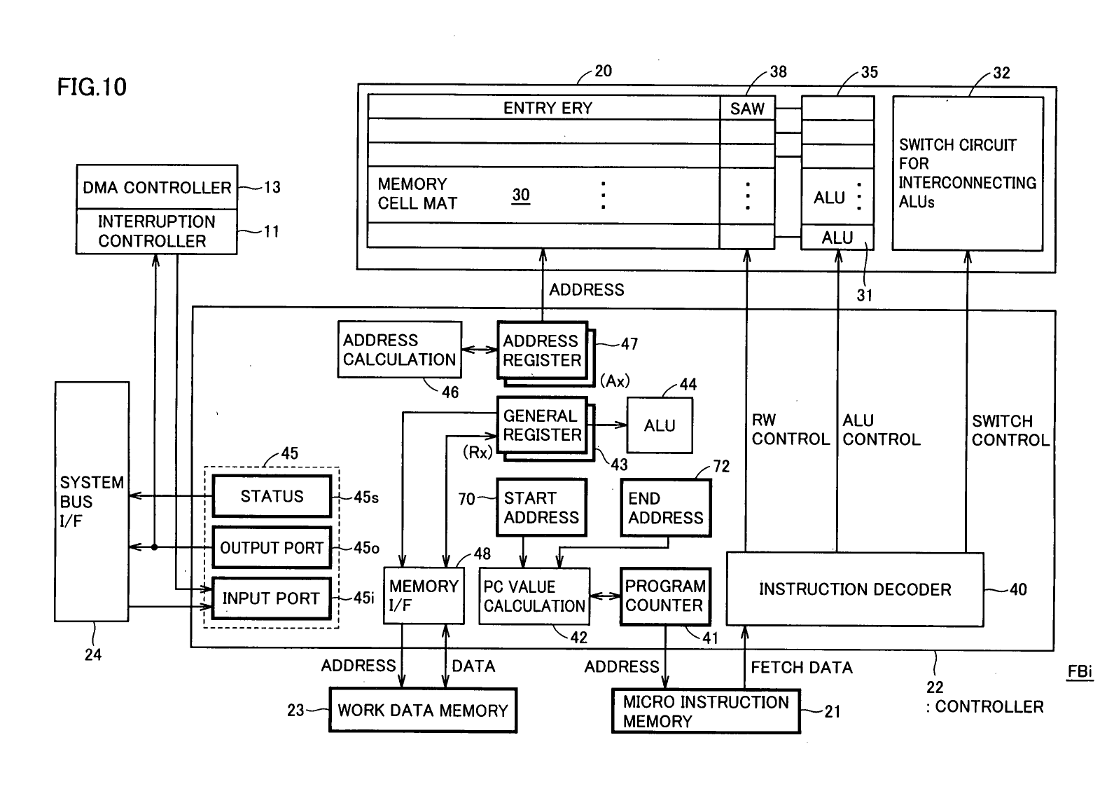

FIG. 10 schematically shows a configuration of the basic operation block FBi according to the second embodiment of the present invention. In basic operation block FBi shown in FIG. 10, the following configuration of controller 22 is different from that of controller 22 according to the first embodiment shown in FIG. 6 described above. Specifically, controller 22 includes a start address register 70 for storing a start address of the loop when a loop instruction is executed, and an end address register 72 for storing a loop end address. Values stored in start address register 70 and end address register 72 are applied to a PC value calculating unit 42. Except for this point, the configuration of controller 22 shown in FIG. 10 is the same as that of controller 22 shown in FIG. 6. Therefore, corresponding portions are denoted by the same reference characters and detailed description will not be repeated.

In the second embodiment, a loop instruction LOOP is additionally prepared, for executing, by one instruction, the subtracting process and the branching process of the loop counter represented by lines #11 and #12 of the micro program shown in FIG. 7.

The instruction “LOOP Rx, Label” is for repeating, by the number of times indicated by the value stored in general register Rx, the operations from the next instruction to the instruction indicated by the label Label. When the loop instruction LOOP is executed, the start address and the end address of the loop instruction are stored in start address register 70 and end address register 72, respectively.

In PC value calculating unit 42, the count value of program counter 41 is compared with the address value stored in the end address register 72. When the count value of program counter 41 matches the end address, the value stored in general register Rx designated as the loop counter is decremented by 1. When the result of subtraction is not 0, the start address stored in start address register 70 is set as the next program count value. When the stored value of general register Rx is 0, the count value of program counter 41 is incremented by 1 and an instruction of the next address is executed, as in a common process.

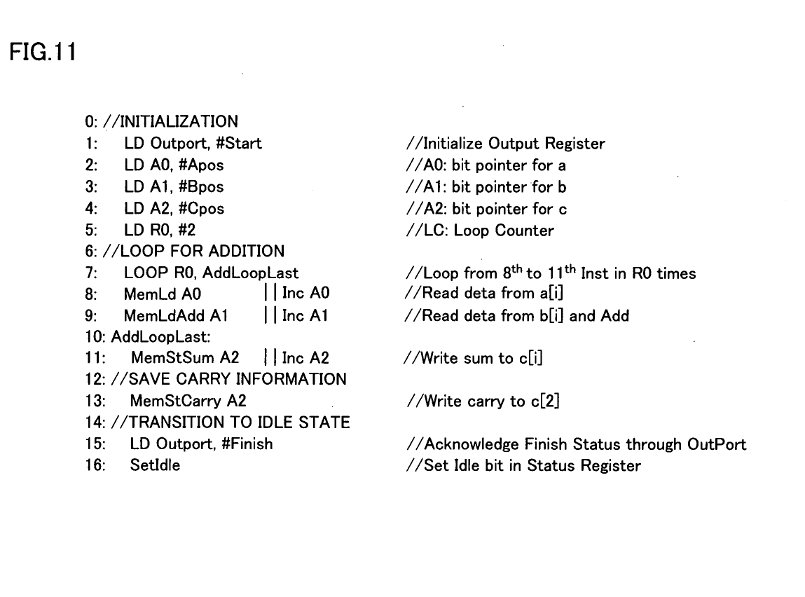

FIG. 11 shows an example of the micro program using the loop instruction LOOP according to the second embodiment of the present invention. The micro program shown in FIG. 11 is for executing the same process as described by the micro program shown in FIG. 7.

As can be seen from FIG. 11, by the instruction of line #5, a constant value 2 is stored in general register R0, and the number of loops is designated. By line #7, loop instructions “LOOP R0, AddLoopLast” is executed. Here, the instruction represented by the label “AddLoopLast:”, that is, the instruction string up to the instruction MemStSum of line #11 is designated to be repeated by the number of times indicated by the value (2) stored in general register R0. The instruction string from line #7 to line #10 differs from the instruction string of the micro program shown in FIG. 7.

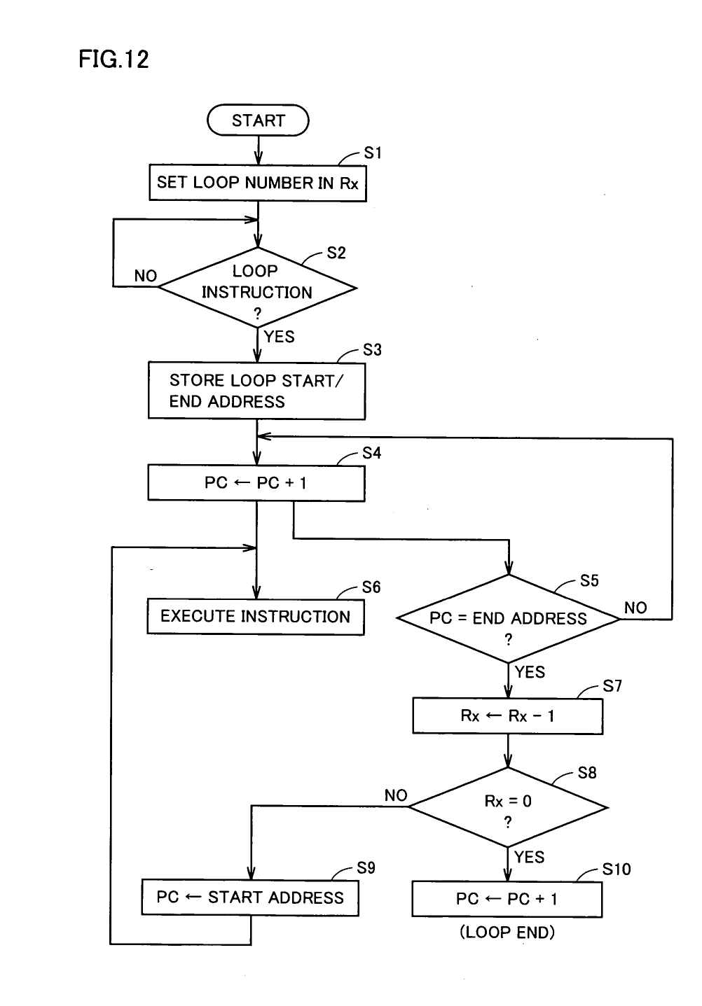

FIG. 12 shows the contents of processing of the loop instruction LOOP. The contents of operation of the loop instruction will be described with reference to FIG. 12. In the following, line numbers of the program shown in FIG. 11 will be referred to.

In the group of instructions from lines #0 to #5, the same process as that shown in FIG. 7 is performed, and output port register 45o is initialized, and address registers A0-A2 and general register R0 are initialized. The number of loops, 2, is set in general register Rx (R0) (step S1).

Thereafter, when the loop instruction is executed in accordance with line #7 (step S2), the start address (address of instruction MemLd of line #8) of the loop and the end address (address of instructions MemStSum of line #11) of the loop are stored in start address register 70 and end address register 72, respectively (step S3). Until the loop instruction is reached, the operation waits for execution of the loop instruction in determination block S2.

After the loop start and loop end addresses are stored, the pointer PC of the program counter is incremented (step S4), and the instruction of the next line #8 is executed (step S6). Accordingly, the memory cell data corresponding to the address stored in address register A0 is loaded to the ALU, and the pointer of address register A0 is incremented by 1.

In parallel with the execution of the instruction in step S6, branch determination is executed from step S5 onward. Now, the counter value of PC value calculating unit 42 is not equal to the end address (step S5), and therefore, the count value PC of program counter 41 is incremented by 1 (step S4), and the instruction MemLdAdd of the next line #9 is executed (step S6). The instruction address (count of program counter 41) of line #9 is not equal to the loop end address, and therefore, the count of program counter 41 is incremented by 1, and the instruction of line #11 designated by the label of the next line #10 is executed (steps S4 and S6).

The instruction address of line #11 (count value of program counter 41) is equal to the end address stored in end address register 72, and therefore, in accordance with the result of determination of step S5, the register value stored in general register R0 is decremented by 1 (step S7).

Thereafter, whether the value Rx stored in the register is equal to 0 or not is determined (step S8) and as it is the first time, the PC value calculating unit 42 sets the count PC of program counter 41 to the start address stored in start address register 70 (step S9) and the operation returns to step S6. Thereafter, operations from step S4 to step S7 are repeated.

In step S8, after the completion of the instruction of line #11, when the register value of general register Rx (R0) attains to 0, it is determined that the loop process has been completed, and PC value calculating unit 42 increments the count of program counter 11 by 1 (step S10). Consequently, the loop processing ends, the instruction of the next line #13 is performed, and the carry is written to the bit position c [2].

Therefore, in the loop instruction LOOP, the loop instruction itself is executed only once, that is, a loop-branch takes place only once and three instructions from line #8 to line #11 are executed as the loop processing.

As for the storage of the end address, when the label AddLoopLast of line #10 is reached, the address of the next instruction may be stored in end address register 72. Even when the end address is stored as the label is reached, the comparison step S5 is executed by the label of line #10, and branch to line #11 or line #7 is determined in accordance with the result of execution of comparison. Therefore, accurate branching process is ensured.

By adding the loop instruction LOOP, the cycle in which the main processing circuit is kept in an operation standby state for determining a loop branch as represented by lines #11 and #12 of the micro program shown in FIG. 7 can be eliminated (in parallel with the execution of the instruction of line #9, loop branch determining process is performed), and therefore, the loop process can be performed with the minimum number of cycles (in the flow chart of FIG. 12, steps S5 to S8 are executed in parallel with the instruction executing step S6).

As described above, according to the second embodiment, as the loop operation instruction is prepared, the time period in which the main processing circuit is in non-operating state can be reduced, and higher speed of processing can be achieved.

### Third Embodiment

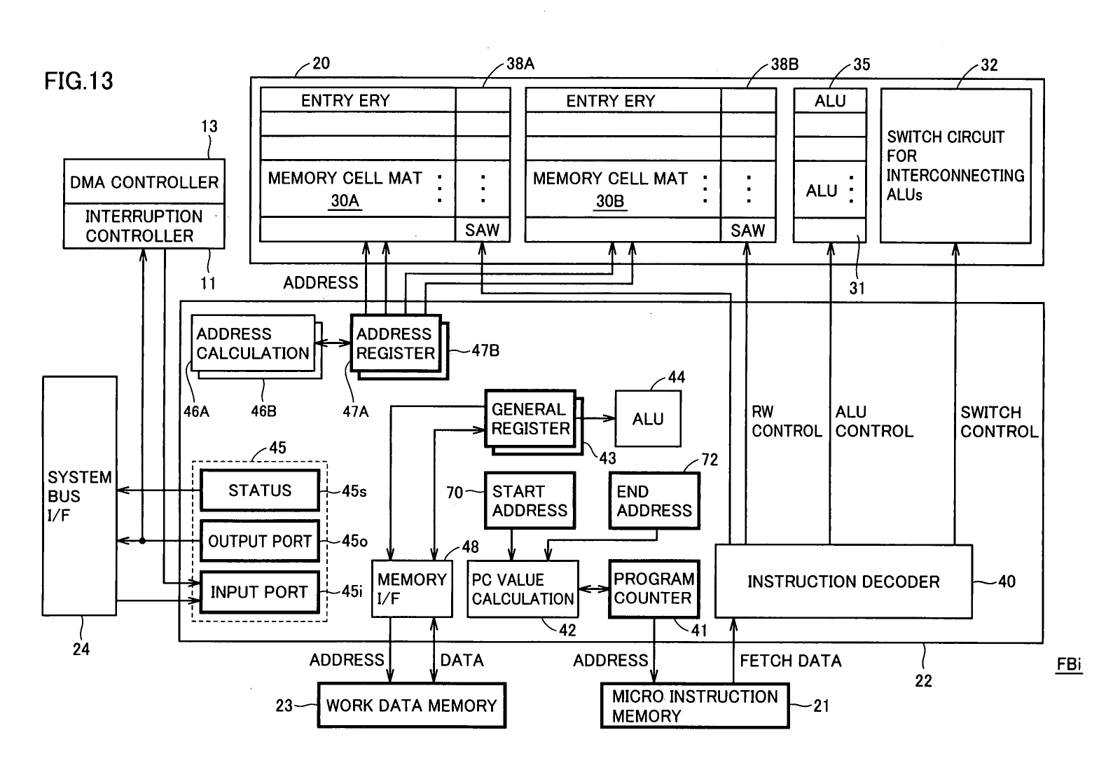

FIG. 13 schematically shows a configuration of the basic operation block FBi according to the third embodiment of the present invention. Referring to FIG. 13, main processing circuit 20 includes two memory mats 30A and 30B. For memory cell mats 30A and 30B, read/write circuits 38A and 38B are provided, respectively. Memory cell mats 30A and 30B have the same configuration, and are each divided into a plurality of entries ERY. In read/write circuits 38A and 38B, for each entry ERY, a sense amplifier and write driver SAW is provided.

The memory cell mats 30A and 30B are coupled to the corresponding ALUs 31 included in the arithmetic logic unit 35 through mutually separate bit line pairs. Therefore, memory cell mats 30A and 30B can be accessed individually and separately. Main processing circuit 20 further includes, as in the first and second embodiments described above, switch circuit 32 for interconnecting ALUs, for switching connection path between ALUs 31 in arithmetic logic unit group 35.

In order to control operations of memory cell mats 30A and 30B, address calculating units 46A and 46B as well as address register groups 47A and 47B are provided. By address calculating unit 46A and address register group 47A, an address for memory cell mat 30A is generated, and by address calculating unit 46B and address register group 47B, an address for memory cell mat 30B is generated. The memory cells included in memory cell mats 30A and 30B are dual port SRAM memory cells having a write port and a read port, as will be described later. The address register groups 47A and 47B each generate a write address and a read address individually and independently.

Instruction decoder 40 generates an ALU control signal defining the contents of an arithmetic/logic operation by arithmetic logic unit 35, and further generates a switch control signal setting the connection path of switch circuit 32 for interconnecting ALUs. Instruction decoder 40 generates a write control signal (write control) for read/write circuits 38A and 38B. The memory cell is an SRAM cell. In the read/write circuit, as for the sense amplifier, the sense amplifier included in the sense amplifier and write driver SAW is always kept active at the time of accessing, and activation/inactivation of the write driver only is set in accordance with the write control signal from instruction decoder 40.

Other configuration of controller 22 shown in FIG. 13 is the same as that of controller 22 in accordance with the second embodiment shown in FIG. 10, and therefore, corresponding portions are denoted by the same reference characters and detailed description will not be repeated.

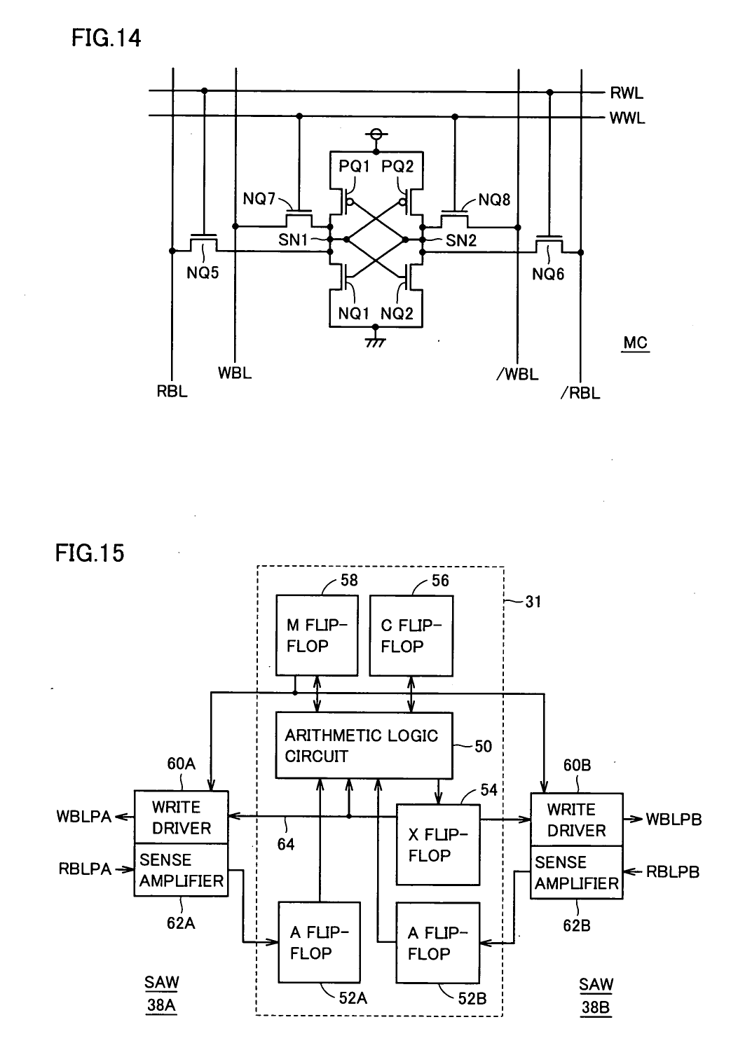

FIG. 14 shows an exemplary configuration of memory cell MC included in memory cell mats 30A and 30B shown in FIG. 13. Referring to FIG. 14, the memory cell MC has a dual port memory cell structure having a write port and a read port provided separately. To the memory cell MC, a read word line RWL and a write word line WWL are provided, and further, read bit lines RBL and /RBL and write bit lines WBL and /WBL are provided. The read port of the memory cell includes N channel MOS transistors NQ5 and NQ6 connecting storage nodes SN1 and SN2 to read bit lines RBL and /RBL, respectively, in response to the signal potential of read word line RWL. The write port of the memory cell includes N channel MOS transistors NQ7 and NQ8 connecting storage nodes SN1 and SN2 to write bit lines WBL and /WBL in response to the signal potential on write word line WWL.

The data storage portion of memory cell MC includes, as that shown in the first embodiment above, load P channel MOS transistors PQ1 and PQ2, and driving N channel MOS transistors NQ1 and NQ2.

By utilizing the dual port memory cell structure shown in FIG. 14, when data processing is performed in a bit serial manner, storage and loading, or writing and reading can be performed concurrently at one time. The area to which the result of operation is written is provided being separate from the area in which the data of the object of operation is stored. Therefore, in a selected memory cell, conflict between the write data and the read data does not occur, and therefore, the problem of address arbitration encountered in a common multi-port memory does not arise.

FIG. 15 schematically shows configurations of the sense amplifier and write driver SAW and ALU 31 in memory cell mats 30A and 30B shown in FIG. 13. Referring to FIG. 15, in read/write circuit 38A, the sense amplifier and write driver SAW includes a write driver 60A coupled to the write bit line pair WBLPA and a sense amplifier 62A coupled to the read bit line pair RBLPA. In read/write circuit 38B, the sense amplifier and write driver SAW includes a write driver 60B coupled to the write bit line pair WBLPB and a sense amplifier 62B coupled to the read bit line pair RBLPB.

As shown in FIG. 15, memory cell mats 30A and 30B are arranged in symmetry with the arithmetic logic unit 35 (ALU 31) being the center. This facilitates interconnection layout of the bit line pairs in memory cell mats 30A and 30B.

Different from the configuration of ALU 31 shown in FIG. 9, ALU 31 includes an A flip-flop 52A for storing output data of sense amplifier 62A, and an A flip-flop 52B for storing output data of sense amplifier 62B. X flip-flop 54 is commonly coupled to write drivers 60A and 60B. To arithmetic logic operation circuit 50, data stored in A flip-flops 52A and 52B are applied as the data to be processed, and the result of operation is stored in X flip-flop 54.

In ALU 31, a C flip-flop 56 for storing a carry or a borrow, and a M flip-flop 58 for storing mask data indicating activation/inactivation of ALU 31 are further provided.

When ALU 31 shown in FIG. 15 is used, in parallel with latching of data from sense amplifiers 62A and 62B, the data of the result of operation can be written from X flip-flop 54, through write driver 60A or 60B.

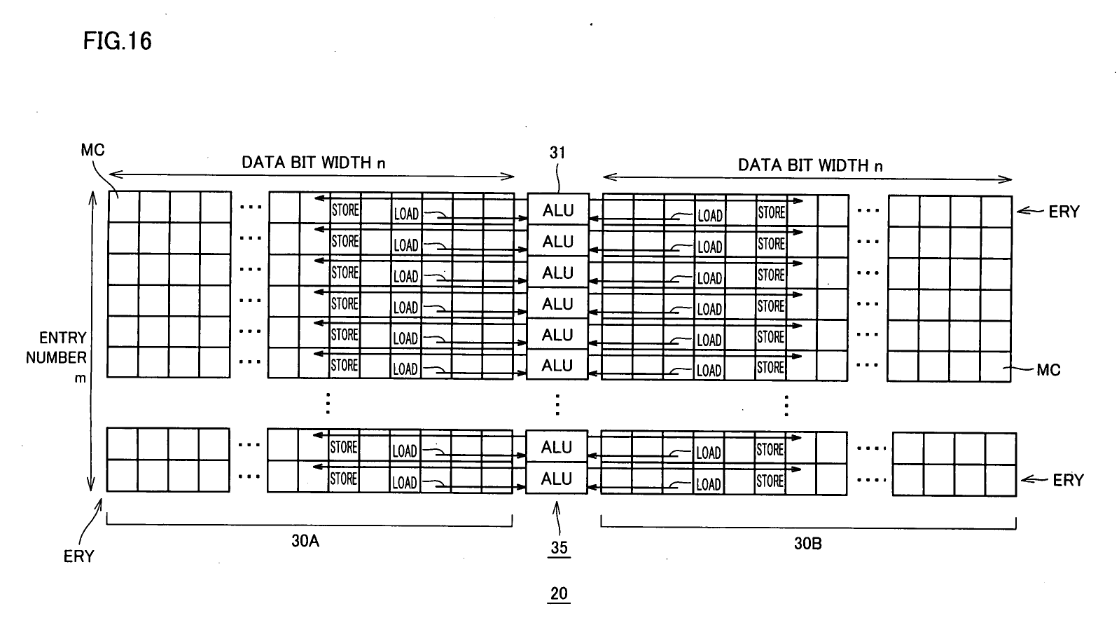

FIG. 16 schematically shows specific arrangement of memory cell mats 30A and 30B included in the main processing circuit 20. In main processing circuit 20 shown in FIG. 16, memory cell mats 30A and 30B are arranged on both sides of the arithmetic logic unit 35. The memory cell mats 30A and 30B have the same configuration, in each of which, m entries ERY each having the data bit width of n bits are arranged.

ALU 31 performs a designated arithmetic/logic operation on the data of the corresponding entry of memory cell mats 30A and 30B. When each ALU 31 is to perform a two-term operation, data to be processed of each term is stored in memory cell mats 30A and 30B, and the result of operation is stored in one of the memory cell mats 30A and 30B.

As the memory cell MC is a dual port memory cell, transfer (load) of the data to be processed to the ALU 31 and transfer (storage) of the data as the result of operation can be performed in parallel.

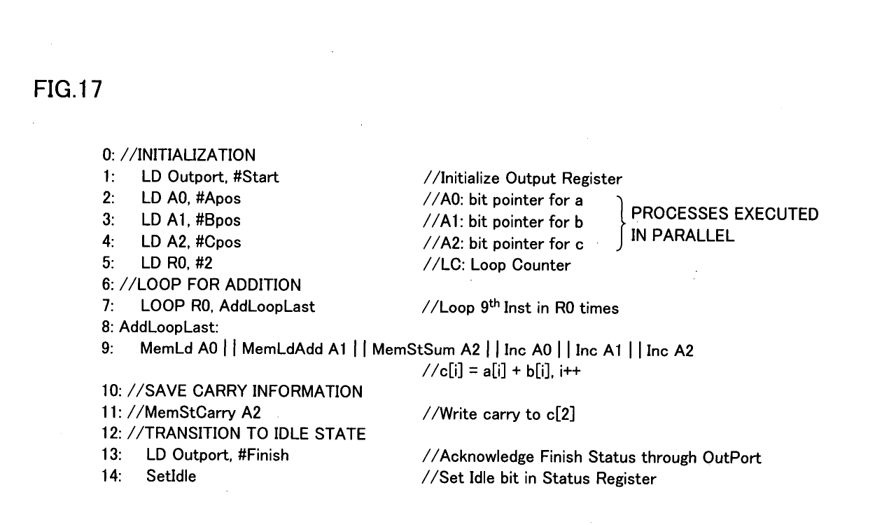

FIG. 17 shows an example of the micro instruction program for executing the two-term addition operation in accordance with the third embodiment of the present invention. In the following, the processing by the basic operation block in accordance with the third embodiment of the present invention will be described with reference to FIG. 16.

In the micro instruction program shown in FIG. 17, from lines #0 to #5, the same process as in the second embodiment described above is executed. Specifically, by the instruction “LD Ax, #imm” from line #2 to #4, head addresses (address of the least significant bit of the data) of data to be accessed are set in address pointers A0-A2. By way of example, an address for memory cell mat 30A is set in address register A0, and an address for memory cell mat 30B is set in address register A1. In address register A2 for storing the address for the data c after operation, a head address of one of the memory cell mats 30A and 30B is set.

By the instruction of line #5, “LD R0, #2”, the number of loops (2) is set in control register R0.

Thereafter, by line #7, the loop instruction is executed, and the address corresponding to the start address (address of the instruction of line #8) of the loop instruction and the address corresponding to the instruction of line #9 are stored as the start address and the end address, respectively. Here, when the label and instruction of lines #8 and #9 are stored in the same address of the micro instruction memory, it follows that the start address and the end address are the same address.

By the group of instructions on line #9, addition, storage of the result of addition and increment of the address are executed in parallel. Specifically, in accordance with the instruction of line #9, the memory cell at the address stored in address register A0 is read and transferred to the corresponding ALU, and in parallel thereto, the data of the memory cell at the address stored in address register A1 is read from the corresponding memory cell mat and transferred to the corresponding ALU. At the time of this transfer operation, the read word lines RWL of the memory cells are driven to the selected state, and through the read bit lines RBL and /RBL, the data are transferred to A flip-flops 52A and 52B of the corresponding ALU.

After the operations of transfer and addition, the result of addition is stored in the address position indicated by address register A2, in the same cycle. At the time of writing, the write word line WWL is driven to the selected state, and through write bit lines WBL and /WBL, the data is transferred. As for the data loading, addition and storage, loading and addition may be performed in the first half cycle and transfer of the result of addition (Sum) may be performed in the second half cycle, in one machine cycle. Alternatively, the storage of the result of addition may be performed in the cycle next to the loading of the data to be processed. In that case, storage is performed in parallel with loading of the next data to be processed.

In parallel with the loading, addition and storage operations, pointer values of address registers A0, A1 and A2 are each incremented by 1.

As the loop instruction LOOP is executed, the process similar to that represented by the flow chart of FIG. 12 is performed. The instruction of line #9 represents the end address of loop instruction, and the value stored in register R0 is decremented by 1 and whether the value stored in the register is equal to 0 or not is determined. As it is the first time operation, the value stored in control register R0 is 1, and therefore, the operation returns to line #8, and the instructions starting at label AddLoopLast are executed.

When the second time loading, addition and storage operations are completed, the value stored in general register R0 is again decremented, and whether the register value is 0 or not is determined. The value stored in general register R0 is 0 at this time, so that the loop instruction execution sequence is completed. The count of the program counter is incremented by 1, the instruction of line #11 is executed, and the carry is stored in a memory cell position designated by address register A2.

Thereafter, in accordance with lines #12 to #14, the same process as in the first and second embodiments above is performed, and as the control bit is stored in the control register, notification of the end of addition is given to an external host CPU and the others.

As the address register groups 47A and 47B are provided separately for memory cell mats 30A and 30B, respectively, the load instruction represented on lines #2 to #4 can be executed in parallel in one cycle (in the program sequence shown in FIG. 17, these are shown being stored successively). Therefore, the number of operation cycles necessary for setting the address pointer can be reduced, and the number of processing cycles can be reduced. When the pointers are to be set in address registers A0-A2, the pointers can be readily set by a micro instruction, which in turn designates address registers A0, A1 and A2 at destination addresses, stores pointer values to be stored in the respective registers in the control field, and stores the instruction “LD” to be executed in the source operand field.

By using the dual port memory cell, in the loop instruction, loading, addition and storage can be executed in one cycle, and therefore, as compared with the process utilizing the loop instruction of the second embodiment above, the number of cycles required for an arithmetic/logic operation can be reduced. Thus, the loop processing with three-times improved performance can be realized.

When the dual port memory cell is used and only one of memory cell mats 30A and 30B is to be used, by providing address calculating units for the read address register and write address register, loading and storage can be executed in parallel, on one memory cell mat.

As described above, according to the third embodiment, the memory cell mat is divided into a plurality of mats, each divided mat has dual port memory cells arranged therein, and address calculating unit and address register group are provided for each memory cell mat. Therefore, loading, arithmetic/logic operation and storage operation can be executed in the same cycle, and high speed processing is achieved.

When data loading, arithmetic/logic operation and storage are to be executed in the same cycle, by way of example, the flip-flops in the ALU are all set to the through state, to transfer all the applied data through the output portions thereof. As the arithmetic/logic operation is executed in a static manner, it becomes possible to perform the arithmetic/logic operation on the transferred data (loaded data) in a static manner, and to transfer the processed data to the target memory cell through the write driver, to write the transferred data therein.

### Fourth Embodiment

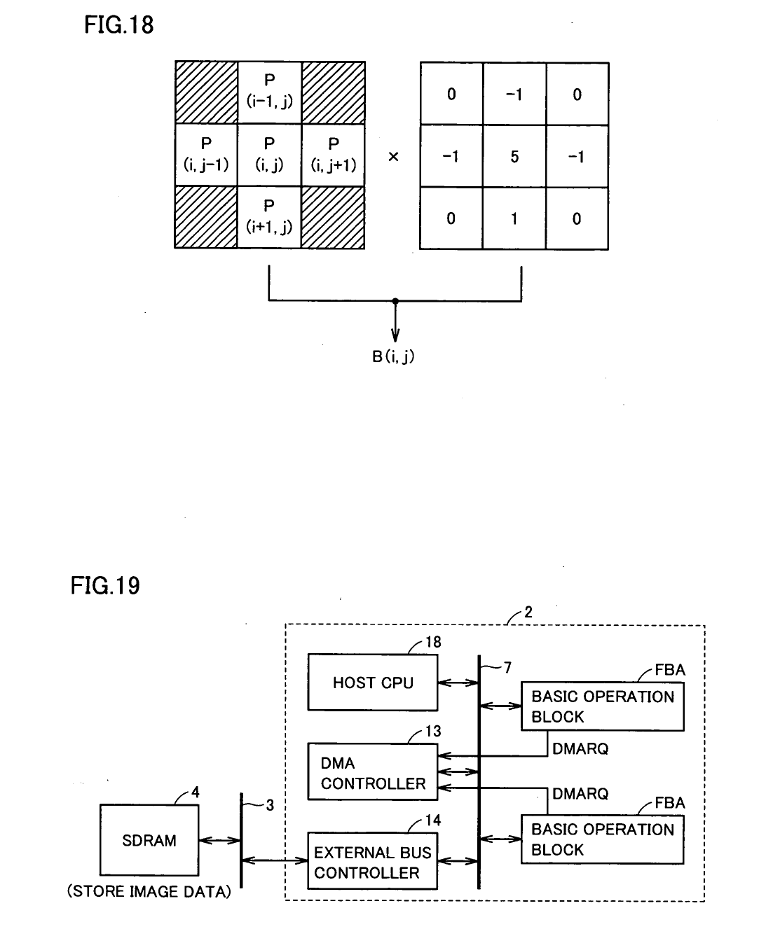

FIG. 18 schematically shows the contents of the arithmetic/logic operation executed as an example in the fourth embodiment of the present invention. In the fourth embodiment of the present invention, image data P is subjected to filtering. Specifically, as shown in FIG. 18, using pixels P (i−1, j), P (i+1, j), P (i, j−1) and P (i, j+1) positioned at up and down and left and right sides of a pixel P (i, j) of interest, a filter matrix shown in FIG. 18 is applied to generate a filtered pixel B (i, j). Consequently, an edge enhanced image is obtained by the filtering process represented by the following equation.
B(i, j)=5·P(i, j)−P(i−1, j)−P(i+1, j)−P(i, j−1)−P(i, j+1), 0≦i<N−1, 0≦j<M−1

Here, N and M represent numbers of rows and columns of pixels in 1 frame of image data. Therefore, in the edge enhancement filtering process, for processing the pixel P (i, j) of interest, data of neighboring four pixels are necessary, in addition to the data of the pixel of interest.

FIG. 19 schematically shows a configuration of a portion related to the filtering of image data, in the signal processing system according to the fourth embodiment of the present invention. Referring to FIG. 19, in system LSI 2, two basic operation blocks FBA and FBB are used. These basic operation blocks FBA and FBB output a DMA transfer request DMARQ to DMA controller 13. When the DMA transfer request is generated, DMA controller 13 reads data of a large capacity memory (SDRAM) 4 coupled to external system bus 3 through an external bus controller 14, and transfers necessary data to basic operation block FBA or FBB, through internal system bus 7.

In SDRAM 4, image data of the object of processing is stored. By way of example, the size of the image data of 1 frame is the VGA (Video Graphic Array) size. In the VGA, 1 frame is formed by 640×480 pixels (M=640, N=480). It is assumed that operation blocks FBA and FBB are each capable of processing data of three rows (lines) of pixels (640×3=1920 pixels). The image data is stored in SDRAM 4, the basic operation blocks FBA and FBB are operated in a pipeline manner, and the filtering process is executed with high throughput.

A string of micro instructions for data transfer between the basic operation blocks and SDRAM 4 for the filtering operation is executed by host CPU 8. A micro program for the filtering process is stored in the micro instruction memories of basic operation blocks FBA and FBB, and the edge enhancement filtering operation is executed under the control of the corresponding controller (21).

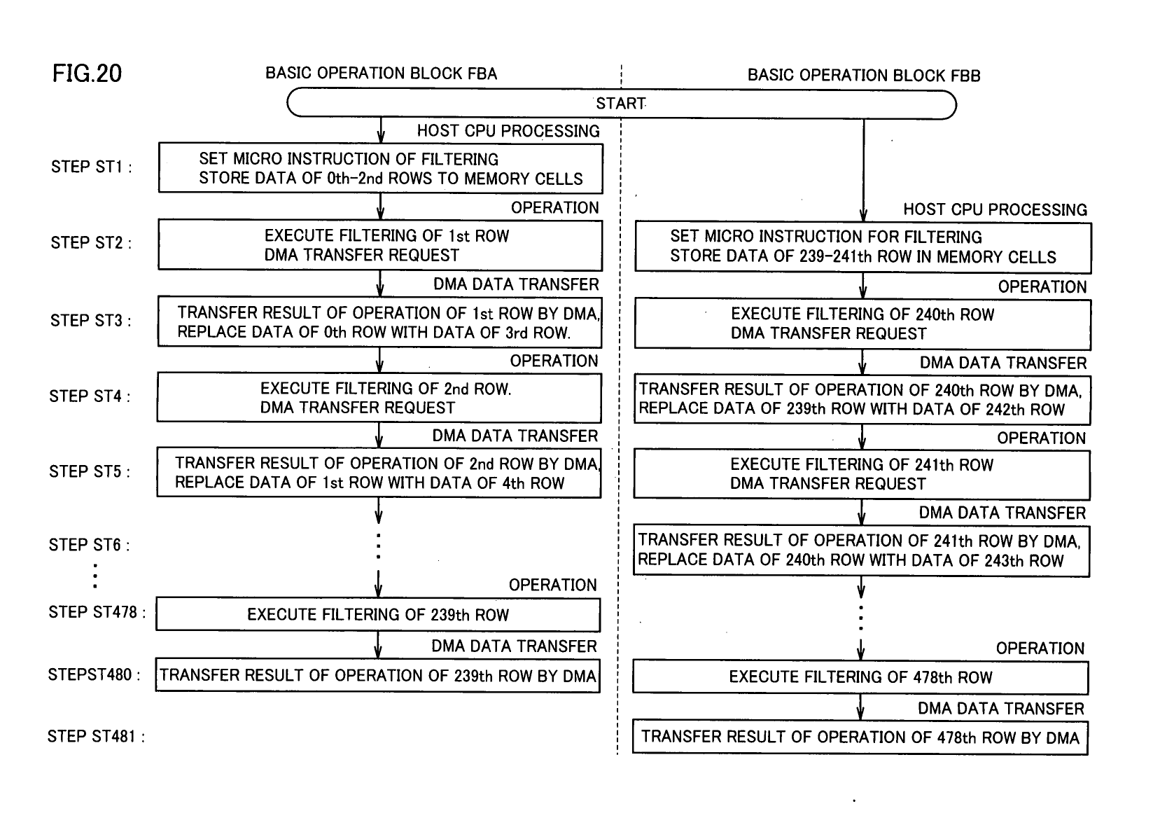

FIG. 20 is a flow chart representing a process sequence by the host CPU of the signal processing system according to the fourth embodiment of the present invention. The operation of the signal processing system shown in FIG. 19 will be described in the following with reference to FIG. 20.

Step ST1:

The micro program for the filtering operation on three rows of pixels for the basic operation block FBA is set in the corresponding micro instruction memory (21). After the setting of the micro program, pixel data of the 0th to 2nd rows (lines) of the frame are transferred from SDRAM 4 through external bus controller 14 and internal system bus 7 to the memory mat of basic operation block FBA. When the transfer operation is complete, the operation of the basic operation block FBA is initiated, and in the basic operation block FBA, the filtering process starts in accordance with the micro program stored in the micro instruction memory. Completion of transfer and storage of data into the memory cell mat can be referenced, by monitoring bit value stored in the status register included in control register group 45, for example. For instance, a bit may be set at the time of data transfer in the input port register 45i shown in FIG. 6, instructing a standby for the operation in the basic operation block FBA.

Step ST2:

In the basic operation block FBA, the filtering operation is executed in accordance with the micro program stored in the micro instruction memory. While the filtering operation on the first row of pixels is being executed in the basic operation block FBA, host CPU 8 similarly stores, in parallel with the operation in the basic operation block FBA, the micro program for the filtering operation on three rows of pixels in the micro instruction memory, in basic operation block FBB, and transfers the pixel data from the 239th to 241th rows from SDRAM 4 to the basic operation block FBB, to store the pixel data in the corresponding memory cell mat.

When the filtering operation on the first row of pixels is complete in basic operation block FBA, a DMA transfer request DMARQ is issued to DMA controller 13. The DMA transfer request DMARQ is issued by, for example, setting a bit in the output port register included in the control register group.

Step ST3:

When receiving the DMA transfer request from basic operation block FBA, DMA controller 13 transfers the data of the result of operation from basic operation block FBA to SDRAM 4, and after the end of transfer, it transfers the pixel data of the third row to the basic operation block FBA. In the basic operation block FBA, in the pixel data storage area for the 0th row, the pixel data of the third row that are newly transferred are successively stored. Thus, the pixel data of the 0th row, of which processing has been complete, are replaced by the new pixel data of the third row.

Concurrently with data transfer in the DMA mode between basic operation block FBA and SDRAM 4, the filtering operation on the pixel data of the 240th row is executed in basic operation block FBB. After the end of the filtering operation, basic operation block FBB issues a DMA transfer request DMARQ through its output port register.

Step ST4:

After the end of transfer of the pixel data of the third row, basic operation block FBA executes the filtering operation on the pixels. In basic operation block FBB, in response to the issuance of the DMA transfer request, the result of filtering operation on the pixels of the 240th row are transferred to SDRAM 4 in the DMA mode, and after the end of transfer, the pixel data of the next, the 242th row, are received from SDRAM 4. The pixel data of the 242th row replaces the pixel data of the 239th row that have been previously stored.

Step ST5:

After the end of filtering operation on the pixel data of the second row in basic operation block FBA, the DMA transfer request is issued and, under the control of the DMA controller, the data of the result of filtering operation on the pixels of the second row are transferred from basic operation block FBA to SDRAM 4, in the DMA mode. After the end of transfer, SDRAM 4 transfers the pixel data of the fourth row to basic operation block FBA. The newly transferred pixel data of the fourth row are stored in the pixel data storage area for the first row of the memory cell mat in basic operation block FBA.

In basic operation block FBB, using the transferred pixel data, the filtering operation on the pixels of the 241th row is executed. After the end of filtering operation, a DMA transfer request DMARQ is issued.

Thereafter, similar processes are executed repeatedly and alternately, following step ST6 and subsequent steps.

Specifically, from step ST5 to step ST481, the processes of steps ST3 and ST4 are repeated 239 times, with the object pixel line incremented one by one. At the end of processing of step ST481, the filtering on pixels of one frame or one image screen has been complete.

As described above, as the DMA transfer and arithmetic/logic operation are alternately executed in basic operation blocks FBA and FBB, efficient processing can be achieved in the system as a whole.

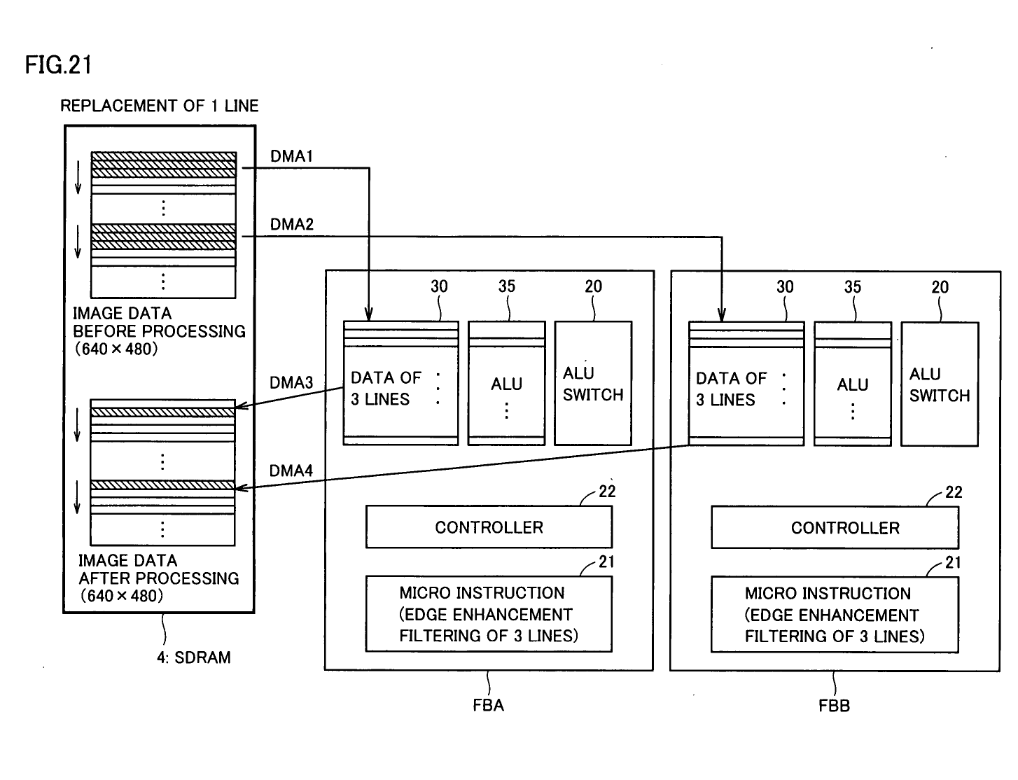

FIG. 21 schematically shows a signal processing sequence of the signal processing system according to the fourth embodiment of the present invention. Referring to FIG. 21, in basic operation blocks FBA and FBB, micro instructions for performing edge enhancement filtering on three lines of pixels are stored in micro instruction memory 21. Controller 22 executes the arithmetic/logic operation in accordance with the micro program stored in the micro instruction memory 21.

In the SDRAM 4, first, under the control of host CPU, pixel data of three lines are stored in memory cell mat 30 of basic operation blocks FBA and FBB, respectively. Thereafter, using a switch circuit (ALU switch) 20 for interconnecting ALUs and arithmetic logic unit 35, each of basic operation blocks FBA and FBB executes the arithmetic/logic operation, under the control of the corresponding controller 22.

When the three-line edge enhancement filtering process is complete on one row (line) of pixels, each of the basic operation blocks FBA and FBB transfers the pixel data of 1 line that has been filtered, to SDRAM 4, in accordance with DMA transfer modes DMA3 and DMA 4. At this time, from SDRAM 4, the next 1 line of unfiltered pixel data is transferred to basic operation blocks FBA and FBB, respectively, in accordance with DMA transfer mode DMA 1 and DMA 2, to replace pixel data of unnecessary line. Therefore, in memory cell mat 30, pixel data of three lines (rows) are stored and the filtering operation is executed.

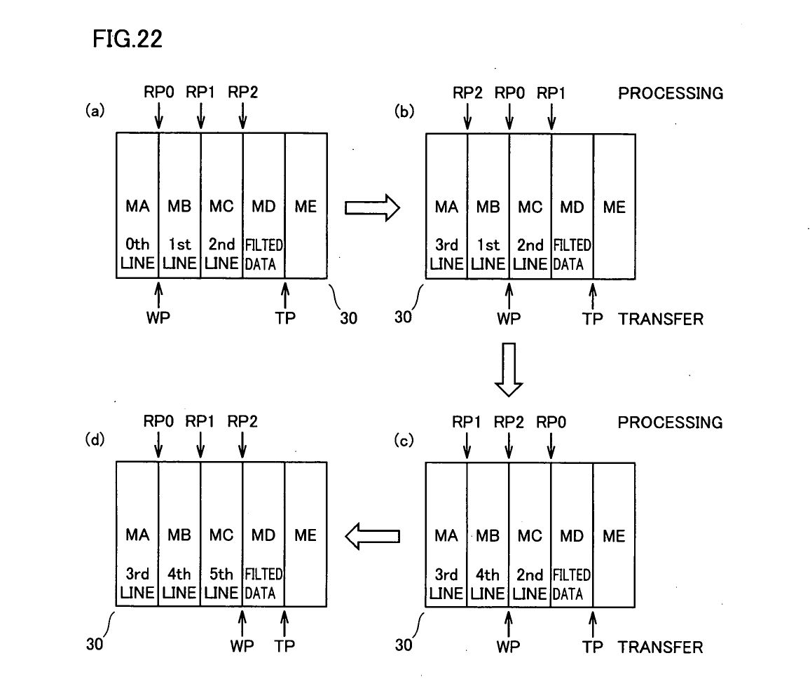

FIG. 22 shows the change of the address pointer in the memory cell mat in DMA transfer. By way of example, memory cell mat 30 is divided into five areas MA-ME. The divided area ME is a work area, which is used as the area for storing intermediate values data. In divided areas MA-MC, pixel data of different rows are stored, respectively. In divided area MD, the result of the filtering operation is stored. As shown in FIG. 22(a), in the initial state, the initial address pointers of divided areas MA, MB and MC are set to RP0, RP1 and RP2, respectively. In divided areas MA, MB and MC, pixel data of the 0th, 1st and 2nd rows (lines) are stored, respectively. Address pointer RP1 designates the area of the pixel data of the object of filtering operation, address pointer RP0 indicates the area of pixels on the row above the pixels of the object of filtering, and pointer RP2 indicates the area of pixels on the line below the line of pixels as the object of filtering. Therefore, in the example of FIG. 22 (a), the filtering operation is executed on the pixel data stored in the divided area MB designated by pointer RP1.

In the DMA transfer mode, write pointer WP designates the divided area MA, and the transfer pointer TP designates the divided area MD. The data after filtering are stored in divided area MD, and in accordance with the transfer pointer TP, the filtered pixel data in divided area MD are transferred. To the area MA designated by write pointer WP, pixel data of the next, third line, are stored. Therefore, at the time when the transfer is complete, pointer RP1 designating the pixels of the object of processing indicates the divided area MC, pointer RP0 designating pixels of the upper line indicates divided area MB, and pointer RP2 designating the area of pixels of the lower line indicates divided area MA. Accordingly, filtering operation is executed on the pixel data of the second row (line), stored in divided area MC.

After completion of the filtering operation on the second row of pixel data, write pointer WP indicates divided area MB. Therefore, pixel data of the second row (after filtering) stored in divided area MD are transferred, and in divided area MB, pixel data of the next row (line), that is, the fourth row (line), are stored. After the storage, respective pointers are shifted as shown in FIG. 22 (c), so that pointer RP1 pointing the area to be processed indicates divided area MA, pointer RP0 designating the pixel area of the upper line indicates divided area MC, and pointer RP2 designating the pixel area of the lower line indicates the divided area MB. Write pointer WP indicates divided area MB. Therefore, in this state, the filtering operation is executed on the third row (line) of pixels in divided area MA pointed by pointer RP1, and the data after filtering are stored in divided area MA. After completion of the operation, in accordance with the transfer pointer TP, the filtered pixel data of the third row (line) in divided area MD are transferred to and stored in the SDRAM, while the pixel data of the next row, that is, the fourth line, are stored in divided area MB pointed by write pointer WP.

After the end of transfer, pointers RP0-RP2 and TP and WP are shifted again, so that pointer RP1 designating the area as the object of processing indicates divided area MB, pointer RP0 designating the pixel area of the upper line indicates divided area MA, and pointer RP2 designating the pixel area of the lower line indicates divided area MC. Write pointer WP indicates divided area MC. Therefore, the positions pointed by the pointers shown in FIG. 22 (d) are the same as the pointer positions shown in FIG. 22 (a). Therefore, by shifting these pointers RP0-RP2, TP and WP by the size of the divided areas successively for each processing, data writing, transfer and storage of the result of operation can be achieved in a simple manner.

Setting of the address pointers can be achieved by using general registers and by an instruction that shifts successively the contents of respective registers every time the edge enhancement filtering on three lines in accordance with the micro program instruction is completed.

As for the procedure of edge enhancement filtering operation, various process flows are possible. One example of the process flow is as follows. Consider an operation of multiplying by 5 the pixel data P (i, j) of the processing target. For this operation, all the bits of pixel data P (i, j) are shifter upward by 2 bits, and the result is stored in divided area ME shown in FIG. 22, whereby 4·P (i, j) is calculated. Thereafter, the pixel data P (i, j) stored in the area designated by pointer RP1 is added to 4·P (i, j), and the result of addition is stored in the storage area of pixel data P (i, j). Consequently, multiplication of 5·P (i, j) is implemented.

Thereafter, pixels P (i−1, j) and P (i+1, j) of the same column are added, and the data P (i−1, j)+P (i+1, j) is stored in divided area ME. Thereafter, from 5·P (i, j), the data stored in divided area ME is subtracted. For the subtracting operation, 2's complement operation is performed. Therefore, first, bit values of the data stored in divided area ME are all inverted, and thereafter, 1 is added, generating −{P (i−1, j)+P (i+1, j)}=A (i, j). Thereafter, by addition of these values, 5·P (I, j)−A (i, j) is generated.

Thereafter, for subtraction of pixel data of an adjacent column, first, by switch circuit 20 for interconnecting ALUs, the ALU path is switched so that data of the adjacent column (stored in the adjacent entry) is transferred. Consequently, the pixel on the right side or the left side is subtracted and the connection path is again switched by ALU switch circuit 20, so that subtraction of the pixel of another adjacent column is performed. By the series of these processes, the above described filtering operation is implemented, and pixel data subject to filtering can be obtained. By the series of operations, complicated filtering operation can be executed in the bit-serial manner.

The switching of connection path and sequences of various operations are all defined by the micro program stored in the micro instruction memory.

As described above, according to the fourth embodiment of the present invention, data transfer in the DMA mode is performed between a plurality of basic blocks and an external large capacity memory, and data transfer and arithmetic/logic operation are performed in a pipeline manner. Therefore, arithmetic/logic operation of a large amount of data can be executed at high speed.

### Fifth Embodiment

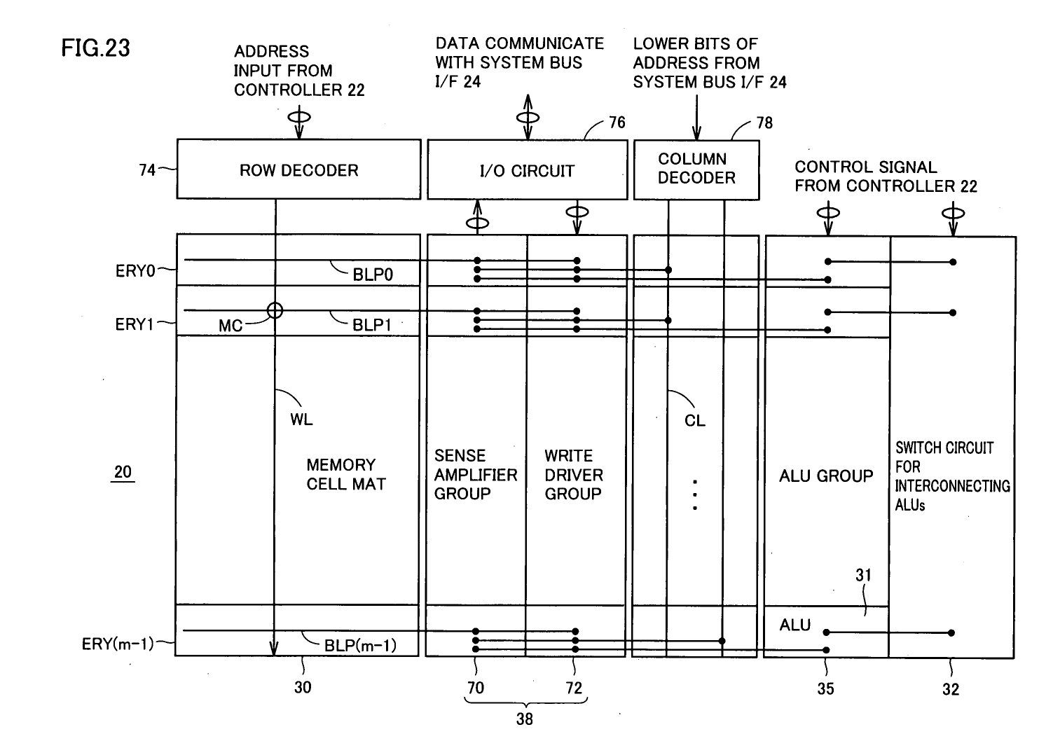

FIG. 23 shows an example of a specific configuration of main processing circuit 20 according to the fifth embodiment of the present invention. In main processing circuit 20, the memory cell MC arranged in memory cell mat 30 is a single port SRAM cell. Word lines WL are arranged corresponding to respective rows of memory cells, and bit line pairs BLP are arranged corresponding to respective columns of memory cells. A memory cell MC is arranged corresponding to a crossing between the bit line pair BLP and word line WL. To the word line WL, memory cells MC of the corresponding row are connected, and to the bit line pair BLP, memory cells MC of the corresponding column are connected.

Entries ERY are provided corresponding to the respective bit line pairs BLP. In memory cell mat 30 shown in FIG. 23, entries ERY0-ERY (m−1) are arranged corresponding to bit line pairs BLP0 to BLP (m−1). Bit line pair BLP is used as a data transfer line between the corresponding entry ERY and the corresponding ALU 31.

For the word lines WL of memory cell mat 30, a row decoder 74 is provided, for driving the word line WL, to which the data bits of the object of operation is connected, to the selected state, in accordance with an address signal from controller 22 or an address signal (and a control signal) from system bus I/F 24. To a common word line WL, memory cells of the same bit position of entries ERY0-ERY (m−1) are connected, and row decoder 74 selects data bits of the same position in entries ERY0-ERY (m−1).

In arithmetic logic unit group 35, ALUs 31 are arranged corresponding to the bit line pairs BLP0-BLP (m−1).

Between arithmetic logic unit group 35 and memory cell mat 30, read/write circuit 38 for loading/storing data is provided. Read/write circuit 38 includes a sense amplifier group 70 and a write driver group 72, respectively including sense amplifiers and write drivers provided corresponding to the respective bit line pairs BLP0 to BLP (m−1).

An input/output circuit 76 for data communication with the system outside through system bus I/F 24 is provided for read/write circuit 38. Input/output circuit 76 performs data transfer between memory cell mat 30 and the internal data bus. The bit width of data input/output of memory cell circuit 76 is set in accordance with the data bit width of system bus I/F 24.

A column decoder 78 is provided for adjustment between the data bit width of input/output circuit 76 and the bit width (m) of the entries connected to one word line WL. By a column selection line CL from column decoder 78, bit line pairs (sense amplifiers or write drivers) are selected by the number according to the bus width of system bus I/F 24. To column decoder 78, a lower bit(s) of the address signal applied from system bus I/F 24 is applied. The number of lower bits is appropriately determined in accordance with the bus width of system bus I/F 24.

The entry selected by column selection line CL is connected to input/output circuit 76, and data is communicated with system bus I/F 24. Thus, data access to memory cell mat 30 through system bus I/F 24 is possible.

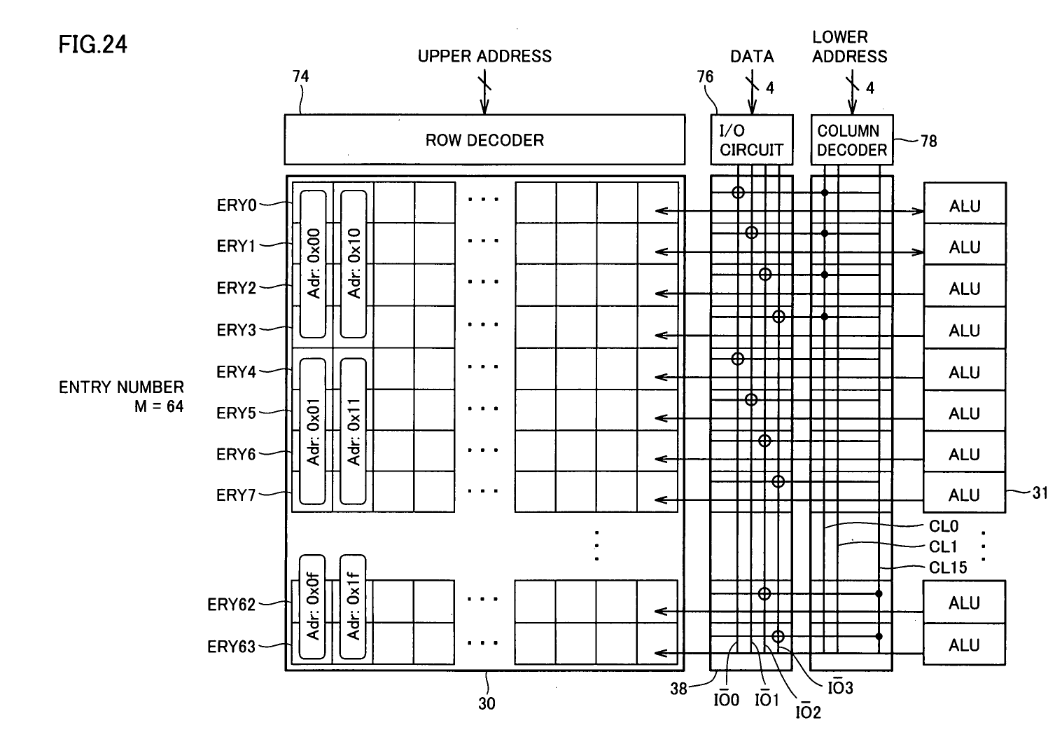

FIG. 24 shows an example of CPU address allocation of the main processing circuit in accordance with the fifth embodiment of the present invention. In the configuration shown in FIG. 24, by way of example, memory cell mat 30 is divided into 64 entries ERY0-ERY63. The number of bits of the upper address applied to row decoder 74 is determined in accordance with the number of word lines (bit width of the entry) included in memory cell mat 30.

In an area of read/write circuit 38, internal data lines IO0-IO3 are arranged, to be coupled to input/output circuit 76. Input/output circuit 76 transfers data of 4 bits. In this case, 4 bits of lower address are applied to column decoder 78. To entries ERY0-ERY3, a column address “0” is allocated, and to entries ERY4-ERY7, a column address “1” is allocated. Subsequently, in the similar manner, a column address “F” (hexagonal notation) is allocated to entries ERY60 (not shown) to ERY63.

Therefore, column decoder 78 performs a 1/16 selection, and when column selection line CL0 is selected, entries ERY0-ERY3 are selected, and when column selection line CL1 is selected, entries ERY4-ERY7 are selected. Similarly, when column selection line CL15 is selected, entries ERY60 to ERY63 are selected.

In accordance with the upper address (for example, “0xx”), a word line is selected by row decoder 74.

As the number of data transfer bits inputted/outputted by input/output circuit 76 is made the same as the bit width of system bus I/F 24 using column decoder 78, it becomes possible for an external host CPU or a DMA controller to access the data in the memory cell mat 30.

Here, the data that can be accessed externally are data at the same bit positions of the plurality of entries. Therefore, when an arithmetic/logic operation is to be executed in the bit-serial manner, data string is rearranged such that respective bits of one data are stored in a common entry.

As described above, according to the fifth embodiment of the present invention, the number of columns selected by column decoder 78 is set such that the bit width of the input/output circuit is made equal to the bit width of system bus I/F, and therefore, an external host CPU or DMA controller can access the data in the memory cell mat 30.

### Sixth Embodiment

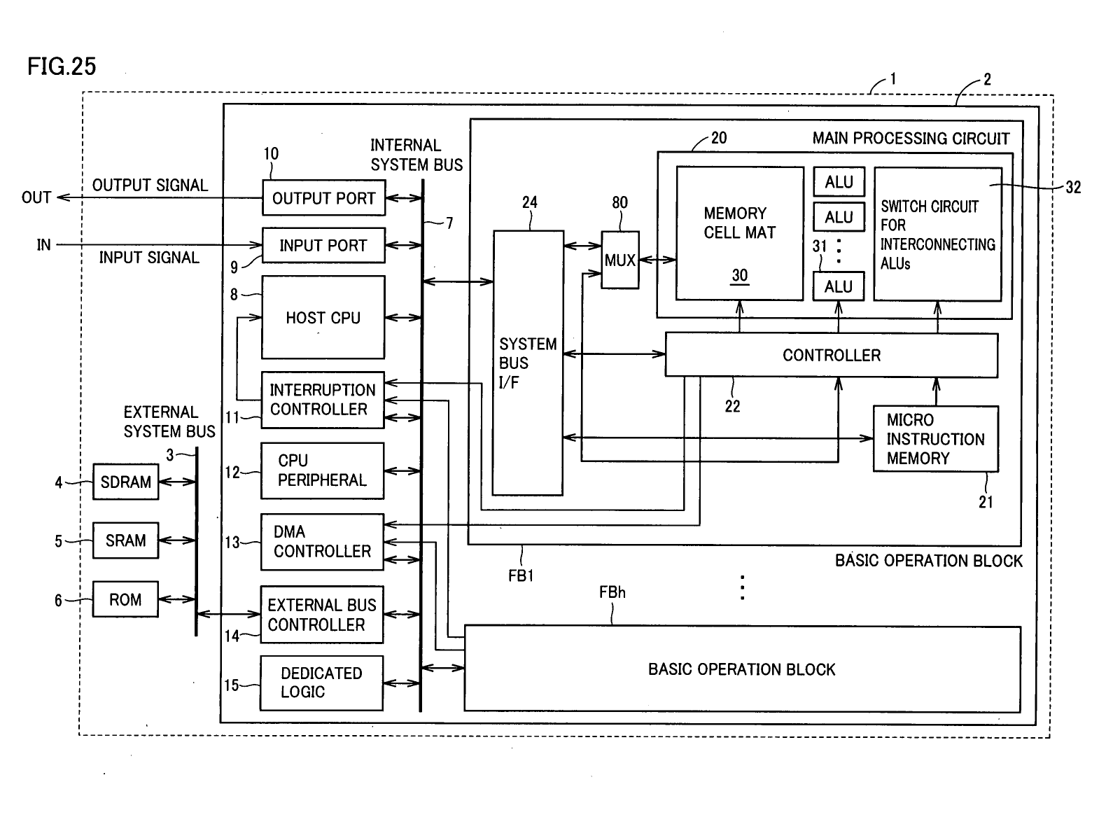

FIG. 25 schematically shows a configuration of the system LSI according to the sixth embodiment of the present invention. FIG. 25 specifically shows only the configuration of basic operation block FB1. In each of basic operation blocks FB1-FBh, a switch circuit (MUX) 80 is provided for transferring the work data from controller 22 to memory cell mat 30. Switch circuit (MUX) 80 couples one of system bus I/F 24 and controller 22 to memory cell mat 30 included in main processing circuit 20. Specifically, switch circuit 80 is coupled to input/output circuit 76 of the main processing circuit shown in FIG. 23.

Except for this point, the configuration of system LSI shown in FIG. 25 is the same as that of system LSI shown in FIG. 1, and therefore, corresponding portions are denoted by the same reference characters and detailed description thereof will not be repeated.

In the configuration shown in FIG. 25, memory cell mat 30 is used as the area for storing data of the object of arithmetic/logic operation, and also used as the work data storage area for controller 22. Therefore, work data memory (23) shown in FIG. 1 becomes unnecessary, and the chip area can be reduced.

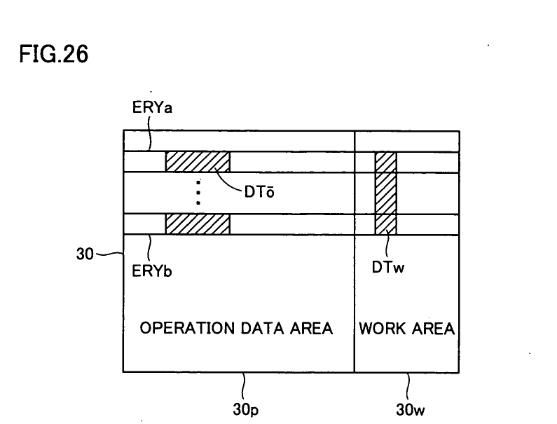

FIG. 26 schematically shows a configuration of a data storage area in memory cell mat 30 according to the sixth embodiment of the present invention. Referring to FIG. 26, memory cell mat 30 includes an operation data area 30p for storing the data for arithmetic/logic operation, and a work area 30w for storing the work data from controller 22. In operation data area 30p, bits of the data DTo of the object of arithmetic/logic operation are stored in the entry ERY (ERYa, ERYb). In work area 30w, bits of work data DTw are stored in the same column (memory cell row) over a plurality of entries (ERYA . . . ERYb). Namely, in operation data area 30p, data that correspond to the external data word with the bit positions rearranged are stored, while in work area 30w, the work data from the controller are stored without rearrangement, that is, each work word is stored at one address position.

In memory cell mat 30, work area 30w is allocated uniformly over the entries of memory cell mat 30, and the work data are stored. Therefore, in each entry, the operation data storage portion and the work data storage portion are allocated uniformly, and it is not the case that a specific area of the entries is used solely for the storage of the work data. Therefore, the performance of parallel operation using the entries is not adversely affected.

In work area 30w, rearrangement of data is not necessary at all, and controller 22 can access the work data DTw through the same operation as the normal work memory access for storing work data.

As described above, according to the sixth embodiment of the present invention, the controller can access the memory cell mat through the switch circuit, and the memory cell mat can be utilized as the operation data and work data storage areas. Therefore, the dedicated work data memory becomes unnecessary and the chip area can be reduced.

### Seventh Embodiment

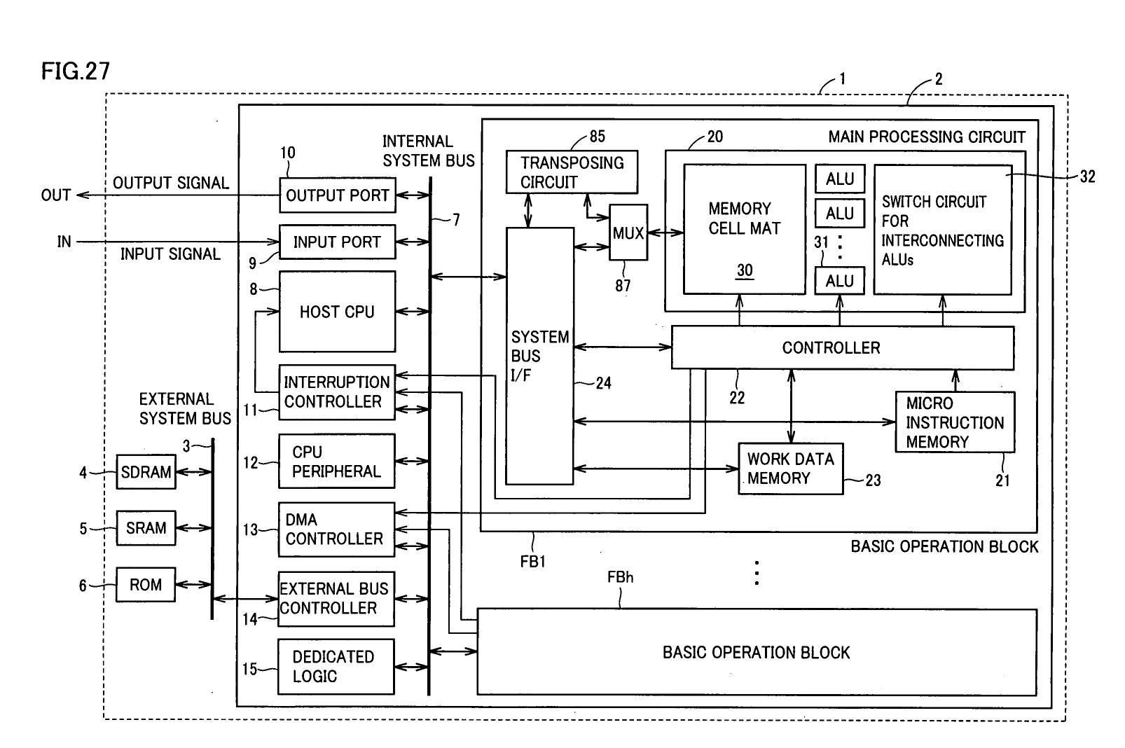

FIG. 27 schematically shows a configuration of a system LSI in accordance with the seventh embodiment of the present invention. In system LSI 2 shown in FIG. 27, in each of basic operation blocks FB1-FBh, between system bus I/F 24 and main processing circuit 20, a transposing circuit 85 for rearranging rows and columns of the applied data, and a switch circuit (MUX 87 for establishing the connection between one of the system bus I/F 24 and the transposing circuit 85 and main processing circuit 20 are provided. As basic operation blocks FB1-FBh have the same configuration, FIG. 27 shows, as a representative, the configuration of basic operation block FB1. Except for this point, the configuration of semiconductor signal processing device 1 shown in FIG. 27 is the same as that of the semiconductor signal processing device shown in FIG. 1. Therefore, corresponding portions are denoted by the same reference characters and detailed description thereof will not be repeated.

Transposing circuit 85 transforms the data that has been transmitted from system bus I/F 24 in a bit-parallel and word-serial manner into a word-parallel and bit-serial manner and writes the transformed data in the entries of the memory cell mat, with the bits at the same positions of different data words written in parallel. Further, transposing circuit 85 transposes data trains transferred in a word-parallel and bit-serial manner from memory cell mat 30 of main processing circuit 20, and transfers the same in a bit-parallel and word-serial manner. This realizes matching of data transfer between system bus I/F 24 and memory cell mat 30.

In the configuration shown in FIG. 27, switch circuit 87 may be configured to select the work data from controller 22 and to transfer the selected data to main processing circuit 20. In that case, work data memory 23 becomes unnecessary. Further, when it is unnecessary to transpose the data of the object of arithmetic/logic operation, switch circuit 87 selects system bus I/F 24 and connects the system bus I/F24 to main processing circuit 20.

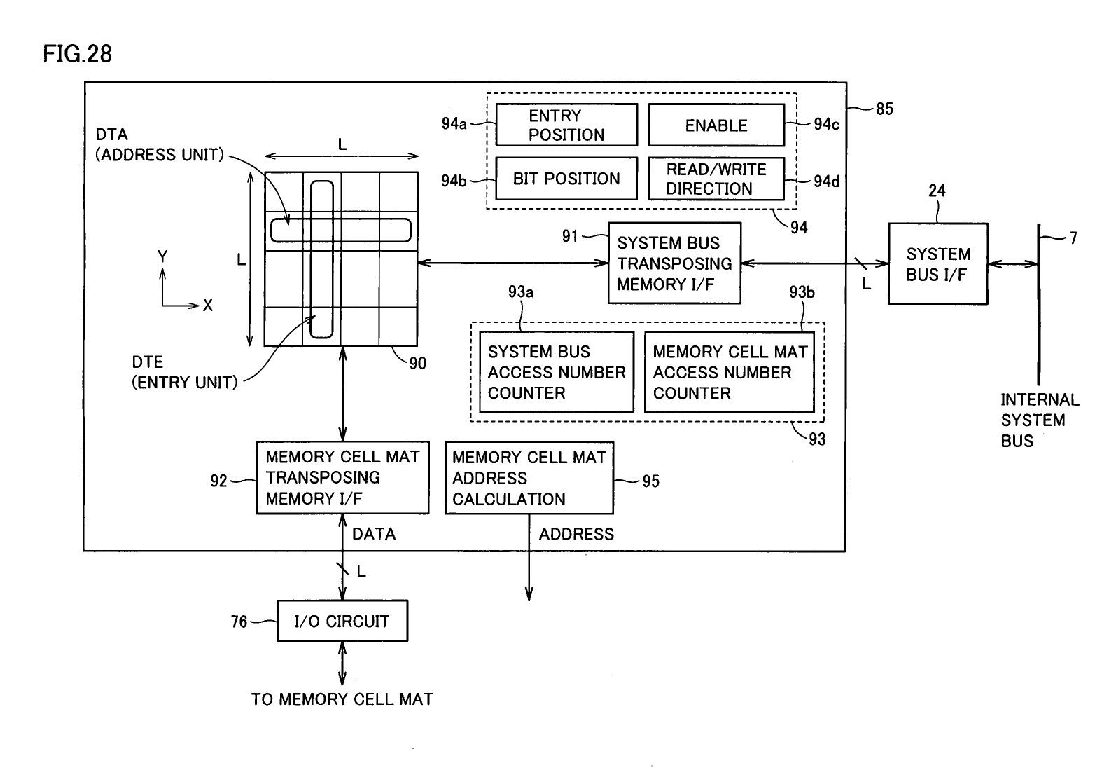

FIG. 28 schematically shows a configuration of transposing circuit 85 shown in FIG. 27. Referring to FIG. 28, transposing circuit 85 includes a transposing memory 90 having storage elements arranged in L rows and L columns, a system bus transfer memory I/F (Interface) 91 for interfacing transposing memory 90 and system bus I/F 24, a memory cell mat transposing memory I/F 92 coupled to transposing memory 90 and input/output circuit 76 through an internal memory bus, for interfacing data transfer with memory cell mat (30), an internal register group 93 for storing information necessary for the internal operation of transposing circuit 85, a control register group 94 for storing address information used in data transfer, and a memory cell mat address calculating unit 95 for calculating and applying to the main processing circuit the address to be accessed of the memory cell mat, based on the information included in internal register group 93.

Data transfer is performed between the memory cell mat and transposing circuit 85 in units of data of L bits. Further, data transfer is performed between transposing circuit 85 and system bus I/F 24, L bits by L bits. The bit width of the internal bus of the memory (IO line shown in FIG. 24) and the bit width of internal system bus 7 are both L bits.

Internal register group 93 includes a system bus access number counter 93a for storing count information of the number of times of accesses to internal system bus 7, and a memory cell mat access number counter 93b for storing count information of the number of times of accesses to the memory cell mat.

Control register group 94 includes an entry position register 94a for storing entry position information, a bit position register 94b for storing bit position information, an enable register 94c for storing a control bit determining activation/inactivation of transposing circuit 85, and a read/write direction register 94d for storing information for setting direction of writing/reading of data by transposing circuit 85. Entry position register 94a and bit position register 94b store the information designating the entry position and the bit position of the memory cell mat, respectively. Contents of the memory cell mat in the designated area are held by transposing memory 90, and transposing circuit 85 functions as a read/write buffer circuit having a function of rearranging the data.

The count values of counter registers 93a and 93b of internal register group 93 indicate the status of storage of the data in transposing memory 90.

System bus transposing memory I/F 91 has a function of controlling data transfer between transposing circuit 85 and internal system bus 7, and at the time of data transfer from transposing circuit 85 to the memory cell mat (memory internal bus), it performs a wait control of a bus request requesting data transfer between internal system bus 7 and transposing memory 90.

Memory cell mat address calculating unit 95 calculates an address of the memory cell mat of the object of data transfer, based on the information stored in entry position register 94a and bit position register 94b, in data transfer to the memory cell mat, and transfers the calculated address to the main processing circuit (transfers the address to row decoder 70 and column decoder 4 shown in FIG. 24).

Transposing memory 90 transfers data to/from system bus transposing memory I/F 91 in the unit of data DTE consisting of bits aligned in the Y direction (data DTE are stored successively along the X direction). As the data word is stored in the same entry in the memory mat, system bus I/F 91 transfers data entry by entry. Meanwhile, at the time of data transfer to/from memory cell mat transposing memory I/F 92, transposing memory 90 transfers data using data bits aligned along the X direction. Specifically, in transposing memory 90, the data DTE aligned along the Y direction are the data for each external address, and in the memory cell mat, correspond to the data for each entry and stored in the same entry. Transposing memory stores the data transferred in the word-serial and bit-parallel as the data DTE. On the other hand, the data DTA along the X direction includes data over a plurality of entries of the memory cell mat and data stored in the same address (word line address) in the memory cell mat, which are transferred in the word-parallel and bit-serial manner, that is, the data of the address unit of the memory cell mat consisting of the bits at the same position of respective entries.

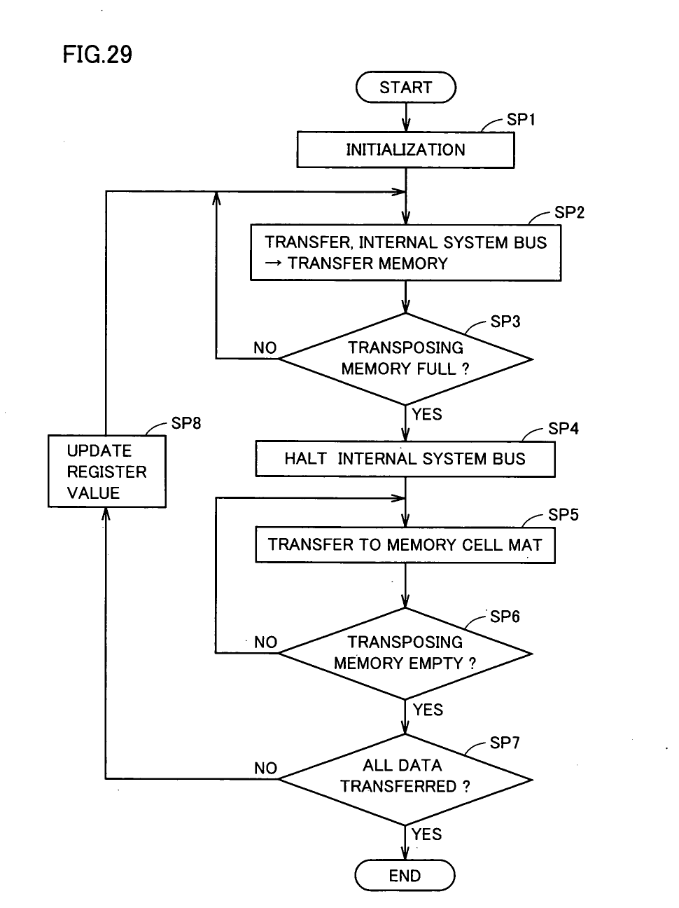

In transposing memory 90, by providing a port for data transfer with the system bus and a port for data transfer with the memory internal bus separate from each other, data transfer becomes possible with the data along the X direction and the data along the Y direction being re-arranged. In the following, an exemplary operation of transposing circuit 85 when data is written from internal system bus 7 through input/output circuit 76 to the memory cell mat will be described with reference to the operation flow of FIG. 29.

Phase 1:

First, the head bit position (word line address) of the object of writing and the entry position (bit line address) of the memory cell mat of the main processing circuit are set in bit position register 94b and entry position register 93a, respectively. Thereafter, a bit indicating writing is set in read/write direction register 90d.

Thereafter, an enable bit is set in enable register 94c, so as to enable transposing circuit 85. By an assertion of the enable bit of enable register 94c, count values of counter registers 93a and 93b included in internal register group 93 are initialized to 0 (step SP1).

Phase 2:

From system bus I/F 24 through system bus transposing memory I/F 91, the transfer data is written to transposing memory 90. The write data to transposing memory 90 is the multi-bit data DTE aligned along the Y direction, and stored successively starting at the head line indicated by the head bit position along the X direction of transposing memory 90. Each time the data is written to transposing memory 90, the count of system bus access number counter register 93a is incremented (step SP2).

Phase 3:

Until the stored contents of transposing memory 90 become full, that is, until the count value of system bus access number counter register 93a reaches the bus width L of the memory internal bus, data writing through system bus transposing memory I/F 91 is continued (step SP3).

Phase 4:

When data writing to transposing memory 90 is performed L times from internal system bus 7 through system bus I/F 24 and system bus transposing memory I/F 91, system bus transposing memory I/F 91 asserts a wait control signal to internal system bus 7 in order to perform data transfer from transposing memory 90 to the memory cell mat, and sets system bus I/F 24 in a state of holding the subsequent data writing in a standby (step SP4). Whether the state of storage of transposing memory 90 is full or not is determined by monitoring the count value of system bus access number counter register 93a.

In parallel with this operation, memory cell mat transposing memory I/F 92 is activated, and reads the data DTA aligned along the X direction of transposing memory 90, and transfers the read out data to input/output circuit 76 (step SP5).

Memory cell mat address calculating unit 95 calculates the address of the memory cell mat of the transfer destination, based on the stored values of entry position register 94a, bit position register 94b and memory cell mat access number counter register 93b, and outputs the destination address in phase with the data sending. Further, in response to the data transmission to memory cell mat, memory cell mat transposing memory I/F 92 increments the count of memory cell mat access number counter 93b.

Phase 5:

Until the storage contents of transposing memory 90 becomes empty, that is, until the storage value of memory cell mat access number counter register 93b attains to L, L-bit-by-L-bit data transfer is continued from transposing memory 90 through memory mat transposing memory I/F 92 (steps SP5, SP6).

Phase 6:

In the determination step SP6 of the flow chart shown in FIG. 29, when it is determined that the storage contents of transposing memory 90 is empty, whether all the transfer data have been transferred or not is determined (step SP7). When the transfer data remains, the count values of access number register counters 93a and 93b are initialized again, and the operation flow returns to step SP2 shown in FIG. 29. At this time, L is added to the storage value of entry position register 94a. When the stored value of entry position register 94a exceeds the number of entries of the memory cell mat, the value of entry position register 94a is set to 0, and the value stored in bit position register 94b is incremented by 1 in order to select the next word line in the memory cell mat (step SP8). System bus transposing memory I/F 91 cancels the waiting state for internal system bus I/F 7, and data writing from internal system bus 7 to transposing memory 90 is started again.

Subsequently, the operation from Phase 2 to Phase 6 described above (that is, the operation of steps SP2 to SP8 shown in FIG. 29) is executed repeatedly.

In step SP7 shown in FIG. 29, when it is determined that all the data have been transferred (determined by de-assertion of transfer request from system bus I/F 24), data transfer ends. By the series of operations described above, it is possible to transform the data transferred externally in word-serial manner to bit-serial and word-parallel data string and to transfer the transformed data to the memory cell mat.

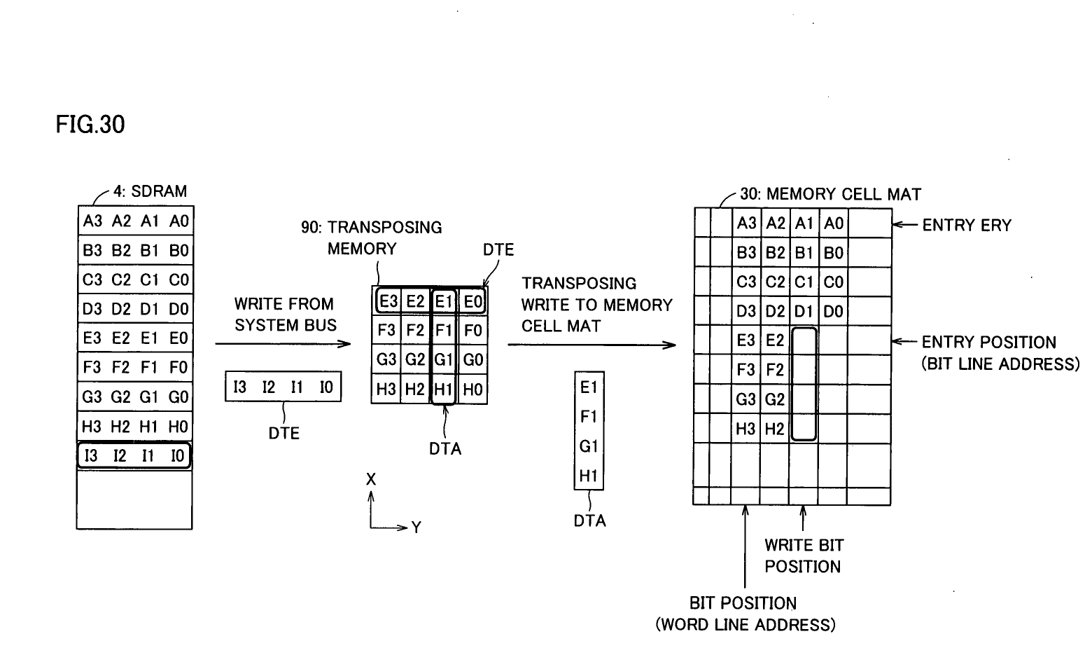

FIG. 30 schematically shows data transfer from SDRAM 4 to memory cell mat 30 shown in FIG. 27. FIG. 30 shows, as an example, data transfer in the case when the internal system bus 7 has the bit width of 4 bits.

Referring to FIG. 30, data A (bit A3-A0) to I (bit I3-I0) each of 4 bits are stored in SDRAM 4. From SDRAM 4 through internal system bus 7, data of 4 bits DTE (data I; bits I3-I0) are transferred to transposing memory 90 and stored therein. The data DTE from SDRAM 4 is the data of entry basis stored in a common entry, and in transposing memory 90, the data bits are stored along the Y direction.

In data transfer from transposing memory 90 to memory cell mat 30, bits of data DTA aligned along the X direction of transposing memory 90 are read in parallel. The data DTA of the address basis consisting of data bits E1, F1, G1 and H1 are stored at positions of memory cell mat 30 indicated by entry position information and write bit position information. The bit position information stored in the bit position register is used as the word line address of memory cell mat 30, and the entry position information is used as the bit line address of memory cell mat 30. The bit position information and the entry position information are stored in entry position register 94a and bit position register 94b, respectively, in the control register group 94 described above. The write bit position information indicating the actual write position of the data is generated by memory cell mat address calculating unit 95, based on the count value of memory cell mat access number counter 93b, the information of entry position register 94a and the bit position information stored in bit position register 94b.

By storing data bits simultaneously in the Y direction and thereafter reading the data bits aligned in the X direction through the use of transposing memory 90, the data DTE of the entry basis read in word-serial and bit-parallel manner from SDRAM 4 can be converted to word-parallel and bit-serial data DTA of address basis, and stored in memory cell mat 30.

The operation when data is read from memory cell mat 30 and transferred to internal system bus 7 is the same as that of data writing to the operation memory cell mat of transposing memory 90, although the direction of data transfer is reversed. The information of the accessing target in memory cell mat 30 in data reading is stored in each register of control register 94, and a bit indicating a data read is set in read/write direction register 94d. Data of the address basis of memory cell mat 30 are read from memory cell mat 30 and successively stored in transposing memory 90, starting at the head position in the Y direction. Thereafter, the data are read from transposing memory 90 successively starting at the head position in the X direction, whereby the data read in the word-parallel and bit-serial manner from memory cell mat 30 can be converted and transferred as word-serial and bit-parallel data.

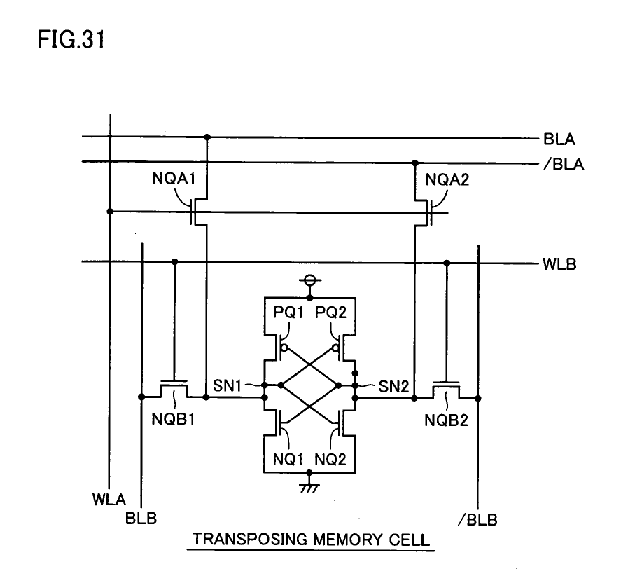

FIG. 31 shows an exemplary configuration of the memory cell included in transposing memory 90. The memory cell included in transposing memory 90 is formed of a dual port SRAM cell. Referring to FIG. 31, the transposing memory cell includes cross-coupled load P channel MOS transistors PQ1 and PQ2, and cross-coupled driving N channel MOS transistors NQ1 and NQ2 for data storage. The transposing memory cell includes, similar to a common SRAM cell, an inverter latch (flip-flop element) as a data storage element, and by the flip-flop element, it stores complementary data in storage nodes SN1 and SN2.

The transposing memory cell further includes N channel MOS transistors NQA1 and NQA2 for coupling storage nodes SN1 and SN2 to bit lines BLA and /BLA, respectively, in response to the signal potential on word line WLA, and N channel MOS transistors NQB1 and NQB2 for coupling storage nodes SN1 and SN2 to bit lines BLB and /BLB in response to the signal potential of word line WLB. Word lines WLA and WLB are arranged orthogonally with each other, and bit lines BLA and /BLA are arranged orthogonally to bit lines BLB and /BLB.

The first port (transistors NQA1, NQA2) formed by the word line WLA and bit lines BLA and /BLA and the second port (transistors NQB1, NQB2) formed by the word line WLB and bit lines BLB and /BLB are coupled to separate transposing memory I/Fs, respectively. By way of example, the first port (word line WLA, bit lines BLA, /BLA) is utilized as a port for the interface with the internal system bus, and the second port (word line WLB and bit lines BLB, /BLB) is utilized as a port for accessing the memory data bus. Consequently, data can be accessed with the rows and columns converted in the transposing memory.

As described above, according to the seventh embodiment of the present invention, a transposing circuit converting rows and columns of the transfer data is used between the system bus and the memory data bus, and therefore, in data transfer between the internal system bus and the memory cell mat, the data having multi-bit width can be transposed, and therefore, the number of times of accesses to the memory cell mat required in data transfer to the memory cell mat can be reduced. Therefore, the time necessary for the data transfer can be reduced, and high speed processing becomes possible.

The semiconductor signal processing apparatus according to the present invention is applicable to a general semiconductor signal processing apparatus that performs image or voice data processing, as well as processing of a large amount of data, and the semiconductor signal processing device in accordance with the present invention is widely applicable to the field of digital signal processing.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductor signal processing device, comprising:
at least one main processing circuit including a memory array having a plurality of memory cells arranged in of rows and columns and divided into a plurality of entries each having a plurality of memory cells, and a plurality of processor circuits arranged corresponding to each entry of said memory array;
a micro instruction memory for storing a micro instruction; and
a control circuit for controlling operations of said memory array and said plurality of processor circuits, in accordance with the micro instruction from said micro instruction memory.

2. The semiconductor signal processing device according to claim 1, wherein
said micro instruction includes a load/store instruction designating data transfer between said memory array and said plurality of processor circuits, and an operation instruction designating contents of an arithmetic/logic operation to be executed by said plurality of processor circuits.

3. The semiconductor signal processing device according to claim 1, further comprising
a register circuit for storing a start address and an end address of a series of operation instructions of said micro instruction memory; wherein
said micro instruction includes a loop instruction for executing an instruction between said start address and said end address repeatedly.

4. The semiconductor signal processing device according to claim 1, wherein
said memory array is divided into a plurality of mats each including the entries, and each of said memory cells is a multi-port memory cell having a write port and a read port; and
said control circuit controls writing and reading of data in parallel, to each of the memory mats.

5. The semiconductor signal processing device according to claim 1, wherein
said at least one main processing circuit comprises a plurality of the main processing circuits provided in parallel;
said control circuit is arranged corresponding to each of the main processing circuits; and wherein
said semiconductor signal processing device further comprises:
a transfer control circuit arranged corresponding to each of the main processing circuits, for performing data transfer between an external memory and a corresponding main processing circuit; and
said transfer control circuit controls operation of the corresponding main processing circuit such that an arithmetic/logic operation and data transfer with said external memory are executed in a pipeline manner, so that while the arithmetic/logic operation is being executed in one main processing circuit, the data transfer with the external memory takes place in another main processing circuit.

6. The semiconductor signal processing device according to claim 1, wherein
each of the entries is formed of the memory cells arranged in a width of a plurality of bits along a direction of the columns in said memory array; and
the main processing circuit further includes
an internal data bus having a bit width smaller than said width of the plurality of bits of each entry,
an entry selecting circuit for concurrently selecting bits at same positions of said plurality of entries in accordance with a first address signal, and
a bit selecting circuit for concurrently selecting bits the same in number as the bus width of said internal data bus from the concurrently selected bits of said plurality of entries, for connection to said internal data bus.

7. The semiconductor signal processing device according to claim 1, further comprising
a system bus for communicating data with an external of the main processing circuit; and
a switch circuit for selecting one of data from said system bus and data from said control circuit, and transferring the selected one to said memory array.

8. The semiconductor signal processing device according to claim 1, wherein
each of the entries is formed of the memory cells arranged in a width of a plurality of bits along a direction of the columns in said memory array; and wherein
said semiconductor signal processing device further comprises
a system bus for transferring data with an external of said main processing circuit; and
a transposing circuit arranged between said system bus and the main processing circuit, for rearranging applied multi-bit data, said transposing circuit transposing the multi-bit data from said system bus such that bits of one multi-bit data are stored in a common entry in the entries.

9. The semiconductor signal processing device according to claim 1, wherein
said memory array is divided into a plurality of mats each including the entries, and
said control circuit controls writing and reading of data in parallel to the mats.
